(19) United States
(12) Patent Application Publication
(10) Pub. No.: US 2013/0191845 A1
(43) Pub. Date: Jul. 25, 2013

(54) LOAD CONTROL DEVICE AND LOAD CONTROL METHOD

(71) Applicant: Fujitsu Limited, Kawasaki-shi (JP)

(72) Inventor: Hideyuki Koumori, Kawasaki (JP)

(73) Assignee: FUJITSU LIMITED, Kawasaki-shi (JP)

(21) Appl. No.: 13/773,901

(22) Filed: Feb. 22, 2013

Related U.S. Application Data
(63) Continuation of application No. PCT/JP2010/005248, filed on Aug. 25, 2010.

(51) Int. Cl. G06F 9/50

(52) U.S. Cl. CPC G06F 9/505
USPC 718/105

(57) ABSTRACT

A load control device controlling a load of an executed program includes an arithmetic processing unit configured to execute the program, a load detection unit configured to detect a load factor of the arithmetic processing unit, a load-difference detection unit configured to obtain a difference between a predetermined load factor and the load factor detected by the load detection unit and a load controller configured to control, for a predetermined time, the start or stop of the program executed by the arithmetic processing unit so that the arithmetic processing unit has the predetermined load factor on the basis of the difference detected by the load-difference detection unit.

### CROSS-REFERENCE TO RELATED APPLICATION

This application is a continuation application of International Application PCT/JP2010/005248 filed on Aug. 25, 2010 and designated the U.S., the entire contents of which are incorporated herein by reference.

### FIELD

The embodiments discussed herein are related to a load control device, a load control method, and a load control program.

### BACKGROUND

In the past, there has existed a central processing unit (CPU) load monitoring device that monitors the operating state (or running state) of a program by monitoring the load factor of a CPU serving as an arithmetic processing unit when the program is executed in a computer serving as an information processing device. Usually the CPU load monitoring device adopts a method where the quantitative load of a CPU is applied onto a computer system.

In a CPU load monitoring device of the related art, in a state where a target program serving as a monitoring target is caused to operate, the CPU load monitoring device is started and the operating state of the program is monitored. At the starting of the CPU load monitoring device, there occurs a problem that the load of a CPU, monitored by the CPU load monitoring device, is added to the load of a computer system in which the target program operates and the load factor of the CPU increases more than expected.

Furthermore, the load factor of the CPU in the computer system fluctuates owing to the operating state of a program other than the target program. For example, when a program other than the target program has operated, a load is applied onto the CPU and hence, the load factor of the CPU increases. On the other hand, when the program other than the target program has stopped, the load of the CPU is deduced and hence, the load factor of the CPU decreases. When the fluctuation of the CPU load of the computer system has occurred, it may have been difficult to maintain the predetermined load factor of the CPU, set by the CPU load monitoring device once. Therefore, it may have been difficult to maintain the load factor of the CPU causing the target program to operate on the computer system.

As the techniques of the related art, Japanese Laid-open Patent Publication No. 2007-18282 and Japanese Laid-open Patent Publication No. 2000-284976 are cited.

### SUMMARY

According to an aspect of the invention, a load control device controlling a load of an executed program includes an arithmetic processing unit configured to execute the program, a load detection unit configured to detect a load factor of the arithmetic processing unit, a load-difference detection unit configured to obtain a difference between a predetermined load factor and the load factor detected by the load detection unit and a load controller configured to control, for a predetermined time, the start or stop of the program executed by the arithmetic processing unit so that the arithmetic processing unit has the predetermined load factor on the basis of the difference detected by the load-difference detection unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a schematic configuration diagram of a server according to a first embodiment;

FIG. 2 is a diagram illustrating a summary of a load control device according to the first embodiment;

FIG. 3 is a diagram illustrating a portion of a parameter file according to the first embodiment;

FIG. 4 is a sequence diagram illustrating an example of an operation of the load control device according to the first embodiment;

FIG. 5 is a sequence diagram illustrating an example of an operation of the load control device according to the first embodiment;

FIG. 6 is a sequence diagram illustrating an example of an operation of the load control device according to the first embodiment;

FIG. 7 is a sequence diagram illustrating an example of an operation of the load control device according to the first embodiment;

FIG. 8 is a sequence diagram illustrating an example of an operation of the load control device according to the first embodiment;

FIG. 9 is a sequence diagram illustrating an example of an operation of the load control device according to the first embodiment;

FIG. 10 is a diagram illustrating a portion of a parameter file according to a second embodiment;

FIG. 11 is a sequence diagram illustrating an example of an operation of a load control device according to the second embodiment;

FIG. 12 is a sequence diagram illustrating an example of an operation of the load control device according to the second embodiment;

FIG. 13 is a diagram illustrating a flowchart illustrating an operation of a command processor according to the first embodiment and the second embodiment;

FIG. 14 is a diagram illustrating a flowchart illustrating an operation of the command processor according to the first embodiment and the second embodiment;

FIG. 15 is a diagram illustrating a flowchart illustrating an operation of a load controller according to the first embodiment and the second embodiment;

FIG. 16 is a diagram illustrating a flowchart illustrating an operation of the load controller according to the first embodiment and the second embodiment;

FIG. 17 is a diagram illustrating a flowchart illustrating an operation of a target monitoring unit according to the first embodiment and the second embodiment;

FIG. 18 is a diagram illustrating a summary of a load control device according to a third embodiment;

FIG. 19 is a diagram illustrating a portion of a parameter file according to the third embodiment;

FIG. 20 is a sequence diagram illustrating an example of an operation of the load control device according to the third embodiment;

FIG. 21 is a sequence diagram illustrating an example of an operation of the load control device according to the third embodiment;

FIG. 22 is a sequence diagram illustrating an example of an operation of the load control device according to the third embodiment;

FIG. 23 is a sequence diagram illustrating an example of an operation of the load control device according to the third embodiment;

FIG. 24 is a sequence diagram illustrating an example of an operation of the load control device according to the third embodiment; and

FIG. 25 is a sequence diagram illustrating an example of an operation of the load control device according to the third embodiment.

### DESCRIPTION OF EMBODIMENTS

Hereinafter, load control devices, load control methods, and load control programs according to the first embodiment, the second embodiment, and the third embodiment of the disclosed technology will be described. In this regard, however, the disclosed technology is not limited to the individual embodiments.

### First Embodiment

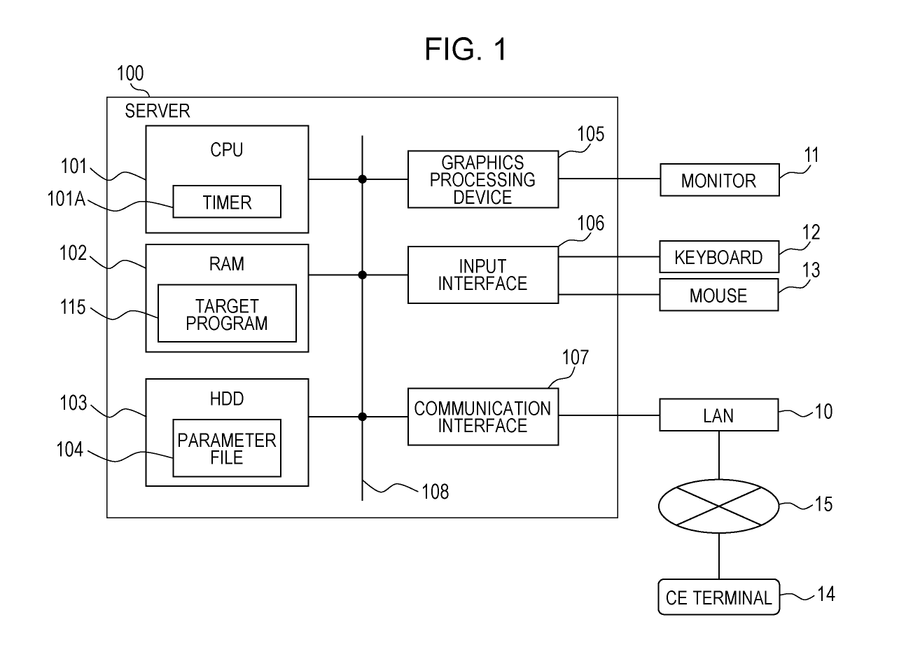

In FIG. 1 to FIG. 9, the load control device, the load control method, and the load control program according to the first embodiment will be described.

FIG. 1 illustrates the configuration diagram of a server 100 serving as an information processing device according to the first embodiment.

The server 100 includes a CPU 101, a random access memory (RAM) 102, a hard disk drive (HDD) 103, a graphics processing device 105, an input interface 106, a communication interface 107, and a bus 108.

The whole server 100 is controlled by an operating system (OS) executed by the CPU 101. The RAM 102, the HDD 103, the graphics processing device 105, the input interface 106, and the communication interface 107 are connected to the CPU 101 through the bus 108.

The CPU 101 includes the function of a timer 101A. The timer 101A functions as a load-time timer, a load monitoring interval timer, and a target monitoring interval timer. The load-time timer has a function for timing a time period (hereinafter, referred to as a “load time”) while a load is applied onto the CPU 101. The load monitoring interval timer has a function for timing an interval of time when the CPU 101 is monitored after the load has been applied onto the CPU 101. As a method for applying a load onto the CPU 101, for example, a method may be cited where investing a thread or a dummy program in a hardware resource such as an arithmetic unit included in the CPU 101 is executed. The thread or the dummy program is an example of a partial program which is a subset of a program executed by the arithmetic unit. The target monitoring interval timer has a function for timing an interval of time when a target program 115A to be a monitoring target is monitored.

The RAM 102 temporarily stores therein, for example, at least portions of an OS program, an application program, the target program 115A, and a dummy program described later, which are to be executed by the CPU 101. The target program 115A is a program to be a monitoring target in the load control device according to the first embodiment. In addition, the RAM 102 stores therein various kinds of data desirable for processing performed in the CPU 101.

In addition, the target program 115A may also be held in a storage medium other than the RAM 102. The target program 115A is stored in a “portable physical storage medium” such as, for example, a flexible disk (FD), a CD-ROM, an MO disk, a DVD disk, a magneto optical disk, or an IC card, which is to be inserted into the server 100. The target program 115A is stored in a disk device included within or without the server 100 or a storage medium held in “another computer (or a server)” connected to the server 100 through a public line, Internet, a LAN, a WAN, or the like. The server 100 reads and executes the target program 115A from the above-mentioned storage medium.

The HDD 103 stores therein, for example, the OS, the application program, and the dummy program described later. The HDD 103 stores therein a parameter file 104 described later.

A monitor 11 is connected to the graphics processing device 105. In accordance with an instruction from the CPU 101, the graphics processing device 105 causes the monitor 11 to display an image.

A keyboard 12 and a mouse 13 are connected to the input interface 106. The input interface 106 transmits, to the CPU 101 through the bus 108, signals sent from the keyboard 12 and the mouse 13.

The communication interface 107 is connected to a local area network (LAN) 10. Through the LAN 10, the communication interface 107 transmits and receives data to and from another server not illustrated and a customer engineer (CE) terminal 14 used by the user of a load control device 1000A described later, for example, a customer engineer (CE).

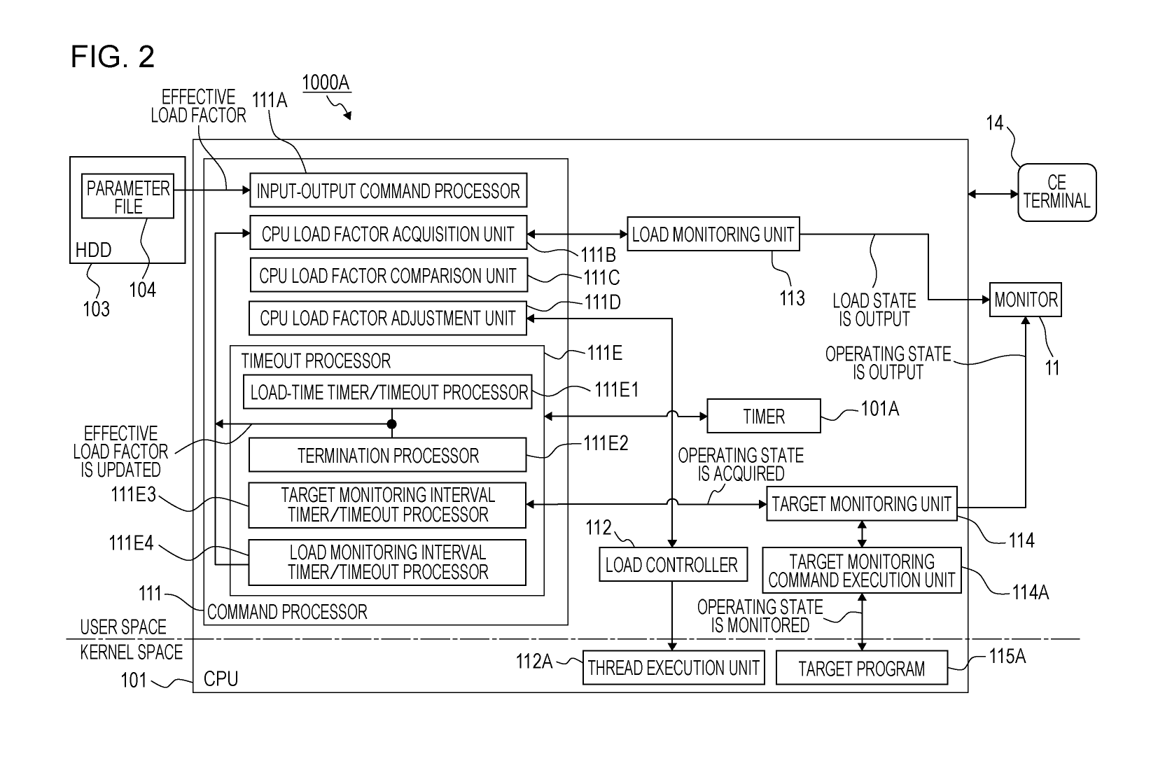

FIG. 2 is a diagram illustrating the summary of the load control device 1000A according to the first embodiment. The load control device 1000A is one of functions executed within the server 100. The load control device 1000A includes functions as a command processor 111, a load controller 112, a load monitoring unit 113, and a target monitoring unit 114, included in the CPU 101.

The command processor 111 includes an input-output command processor 111A, a CPU load factor acquisition unit 111B, a CPU load factor comparison unit 111C, a CPU load factor adjustment unit 111D, and a timeout processor 111E. The command processor 111 reads the definition content of the parameter file 104 stored in the HDD 103. In accordance with the value of the read definition content of the parameter file 104, the command processor 111 sets the effective load factor of the CPU 101.

In the input-output command processor 111A, owing to the definition content of the parameter file 104 read from the HDD 103, for example, a target onto which a load is to be applied, how to apply a load, the degree of a load, a time when a load is applied, the monitoring interval of the above-mentioned load, and the monitoring time of the above-mentioned program are defined. For example, investing a thread or a dummy program in a hardware resource such as an arithmetic unit included in the CPU 101 is executed, and hence, a “load” onto the CPU 101 is applied. The input-output command processor 111A acquires a request to start the command processor 111, from the CE terminal 14 used by, for example, the customer engineer (CE) serving as the user of the load control device 1000A. In accordance with a call request from the CE terminal 14 through the input-output command processor 111A, the command processor 111 is called.

When, from the CE terminal 14 through the input-output command processor 111A, having acquired a request to acquire the current load factor of the CPU 101, the CPU load factor acquisition unit 111B calls the load monitoring unit 113 and acquires the current load state of the CPU 101. In addition, the load monitoring unit 113 is configured owing to, for example, software.

When having acquired the current load factor of the CPU 101 from the CPU load factor acquisition unit 111B, the CPU load factor comparison unit 111C obtains a difference between the acquired current load factor and the set effective load factor.

The CPU load factor adjustment unit 111D causes the load controller 112 to start. In addition, the CPU load factor adjustment unit 111D calls the load controller 112 in accordance with the difference, detected by the CPU load factor comparison unit 111C, between the current load factor and the set effective load factor, and requests the load controller 112 to execute or halt investing a thread in the thread execution unit 112A in the CPU 101. In addition, the thread is the executable unit of a dummy program executed by the CPU 101. As the thread, for example, the thread, task, or process of a dummy program for adding a predetermined CPU load factor to the CPU 101 may also be used, the dummy program being started in the load controller 112. By executing or halting investing a predetermined number of threads in the thread execution unit 112A, it may be possible for the load controller 112 to adjust the load of the CPU 101.

The timeout processor 111E includes a load-time timer/timeout processor 111E1, a termination processor 111E2, a target monitoring interval timer/timeout processor 111E3, and a load monitoring interval timer/timeout processor 111E4. The timeout processor 111E performs processing after a time for applying a load, a target monitoring time, and a load monitoring time, individually set for the timer 101A functioning the load-time timer, the target monitoring timer, and the load monitoring timer, have elapsed, namely, timed out.

After the set time for applying a load has elapsed and the load-time timer has timed out, the load-time timer/timeout processor 111E1 requests to implement processing for terminating investing a thread in the thread execution unit 112A, the processing being set in the termination processor 111E2. Alternatively, when the set time for applying a load has elapsed, the load-time timer/timeout processor 111E1 performs processing for causing the CPU load factor acquisition unit 111B to update the effective load factor of the CPU 101.

When having acquired, from the load-time timer/timeout processor 111E1, the request to implement the termination processing after the load-time timer has timed out, the termination processor 111E2 performs processing for causing the load controller 112 to be halted.

After the set target monitoring time has elapsed and the target monitoring interval timer has timed out, the target monitoring interval timer/timeout processor 111E3 calls the target monitoring unit 114 and acquires operation information indicating the state of the current operation of the target program 115A.

After the set load monitoring time has elapsed and the load monitoring interval timer has timed out, the load monitoring interval timer/timeout processor 111E4 requests the CPU load factor acquisition unit 111B to acquire the current CPU load factor.

When the target program 115A in a user space or a kernel space from among an address space handled by the OS operates, the load controller 112 controls a load in a system program area, such as the OS (system program) operating in the kernel space, and a load in a user program area, such as an application program executed in the user space, in the CPU 101. The kernel space is, for example, the space of the CPU 101, used by a kernel serving as the kernel of an OS. The user space is, for example, the space of the CPU 101, used by an application program. In the first embodiment, the target program 115A and the thread execution unit 112A exist in the kernel space.

The load controller 112 is called owing to a call request from the CPU load factor adjustment unit 111D. When having acquired, from the CPU load factor adjustment unit 111D, a request to increase or decrease the load factor of the CPU 101, the load controller 112 executes or halts investing a thread in the thread execution unit 112A, and hence, causes a load applied to the system program area in the CPU 101 to be increased or decreased. When having acquired, from the termination processor 111E2, a halt request, the load controller 112 halts the execution of a thread due to the thread execution unit 112A.

The load monitoring unit 113 monitors a load in the system program area and a load in the CPU 101 with respect to each user program area. When having acquired, from the CPU load factor acquisition unit 111B, a request to acquire the CPU load factor, the load monitoring unit 113 acquires the load factors of the system program area and the user program area in the CPU 101 and outputs, to the CPU load factor acquisition unit 111B, the acquired load factor of the CPU 101 in each area. The load monitoring unit 113 outputs, to the monitor 11, the load information of the CPU 101 including the load factor of the CPU 101 in each of the system program area and the user program area.

When the target monitoring unit 114 has acquired, from the target monitoring interval timer/timeout processor 111E3, a request to acquire the operating state of the target program 115A, the target monitoring unit 114 monitors the operating state of the target program 115A operating in the system program area of the OS (system program) or the like operating in the kernel space. The target program 115A according to the first embodiment is executed in, for example, the kernel space. The target monitoring unit 114 activates, for example, a command used for target monitoring, preliminarily set in a “target monitoring command” of the parameter file 104 described later. The target monitoring command execution unit 114A executes the “target monitoring command” activated by the target monitoring unit 114, and monitors the operating state of the target program 115A.

The operating state of the target program 115A is determined on the basis of, for example, the value of a return value (returned value) at the time of the return of a command and a measured time having elapsed before the return. As an example, a case where the value of the “return value (returned value)” is “0” indicates a normal operation, and a case of “1” indicates that an error has occurred. When the time having elapsed before the return of the command is greater than or equal to, for example, 60 seconds, the CE determines that a command return time is not tolerated in the actual operation of the server 100, and determines as an error. Upon receiving an operating-state-acquisition state from the target monitoring command execution unit 114A, the target monitoring unit 114 gives notice of the operating state of the target program 115A, acquired by the target monitoring interval timer/timeout processor 111E3. In addition, the target monitoring unit 114 outputs, to the monitor 11, the acquired operating state of the target program 115A.

The target program 115A is a program to be a target for monitoring in the load control device 1000A according to the first embodiment. The target program 115A according to the first embodiment is executed in, for example, the kernel space.

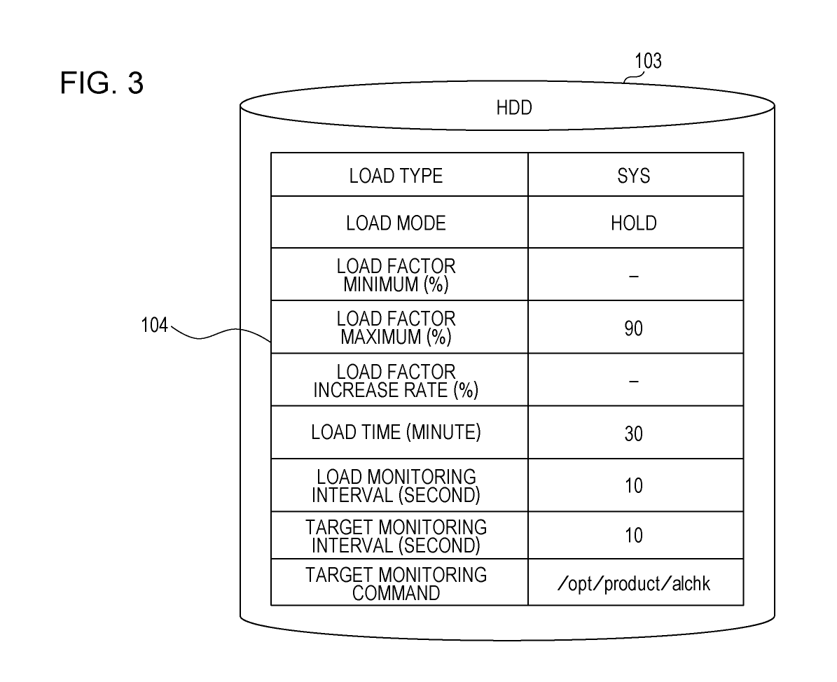

FIG. 3 is a diagram illustrating an example of the parameter file 104 according to the first embodiment. The parameter file 104 is stored in, for example, the HDD 103 illustrated in FIG. 1 and FIG. 2. In the parameter file 104, parameters are set that include, for example, a load type, a load mode, a load factor minimum (%), a load factor maximum (%), a load factor increase rate (%), a load time (minute), a load monitoring interval (second), a target monitoring interval (second), and a target monitoring command.

The load type is an item used for setting in which area of the system program area operating in the kernel space and the user program area operating in the user space, from among the address space of the OS executed by the CPU 101, the load controller 112 according to FIG. 2 invests a thread in the thread execution unit 112A in the CPU 101 so as to apply a load. In the load control device 1000A according to the first embodiment, “SYS” is input that indicates a setting for applying a load onto the system program area side of the CPU 101 by executing the thread execution unit 112A serving as a thread on the system program area side. In addition, when “USR” is input in the load type, a thread execution unit 112B serving as a thread on a user program area side is executed and a load is applied onto the user program area side of the CPU 101.

The load mode is an item used for setting how to apply a load owing to the execution of the thread of the thread execution unit 112A when the load controller 112 according to the FIG. 2 applies a load onto the CPU 101. In the load control device 1000A according to the first embodiment, “HOLD” is input that indicates that a fixed load set in the load factor maximum (%) is to be applied onto the CPU 101 owing to the execution of the thread of the thread execution unit 112A. When the load mode is “HOLD”, the items of the load factor minimum (%) and the load factor increase rate (%) are not set or values set therein are ignored.

The load time is an item used for setting a time for applying a load onto the CPU 101 by the load controller 112 investing a thread in the thread execution unit 112A in the CPU 101. In the load control device 1000A according to the first embodiment, the time for applying a load is set as 30 minutes.

The load monitoring interval is an item used for setting a time interval when the load monitoring unit 113 according to FIG. 2 monitors the load of the CPU 101. In the load control device 1000A according to the first embodiment, the load monitoring interval is set as 10 seconds.

The target monitoring interval is an item used for setting a time interval when the target monitoring unit 114 according to FIG. 2 monitors the operating state of the target program 115A. In the load control device 1000A according to the first embodiment, the monitoring interval of the target program 115A is set as 10 seconds.

The target monitoring command is an item used for setting the type of a command where the target monitoring unit 114 according to FIG. 2 monitors the operating state of the target program 115A. By activating a command used for monitoring a target, preliminarily set in the “target monitoring command”, the target monitoring unit 114 according to the first embodiment monitors the operating state of the target program 115A. For example, by acquiring the value of the return value (returned value) at the time of the return of the command used for monitoring the corresponding target or by measuring a time having elapsed before the return of the command, the target monitoring unit 114 monitors the operating state of the target program 115A.

In addition, in the load mode, in addition to “HOLD”, “UP” exists. When the load mode is “UP”, a fixed load set as the load factor minimum (%) is applied onto the CPU 101 only for a time set as the load time (minute), by executing the thread of the thread execution unit 112A. Next, after the load time (minute) has elapsed, the load control device 1000A adds the load factor increase rate (%) to the load factor minimum (%). A result obtained by the addition is set as an effective load factor (hereinafter, referred to as an “effective load factor after the addition of the load factor increase rate”). Next, the load control device 1000A applies the set effective load factor onto the CPU 101 only for a time set as the load time (minute).

Next, after the load time (minute) has elapsed, the load control device 1000A sets a second effective load factor after the addition of the load factor increase rate, by adding the load factor increase rate (%) to the effective load factor (%) after the addition of the load factor increase rate. Next, the load control device 1000A applies the set second effective load factor after the addition of the load factor increase rate, onto the CPU 101 only for a time set as the load time (minute).

In this way, the load control device 1000A adds the load factor increase rate (%) to the load factor minimum (%) in a stepwise fashion, and applies onto the CPU 101 only for a time set as the load time (minute). When the value of the effective load factor after the addition of the load factor increase rate, obtained by adding the load factor increase rate (%) to the load factor minimum (%) in a stepwise fashion, becomes larger than the load value maximum (%), the load control device 1000A halts processing for adding the load factor increase rate (%) to the effective load factor (%) after the addition of the load factor increase rate in a stepwise fashion. At the same time, the load control device 1000A calls the load controller 112 using the command processor 111, and notifies the load controller 112 of an instruction for halting the activation of the thread of the thread execution unit 112A.

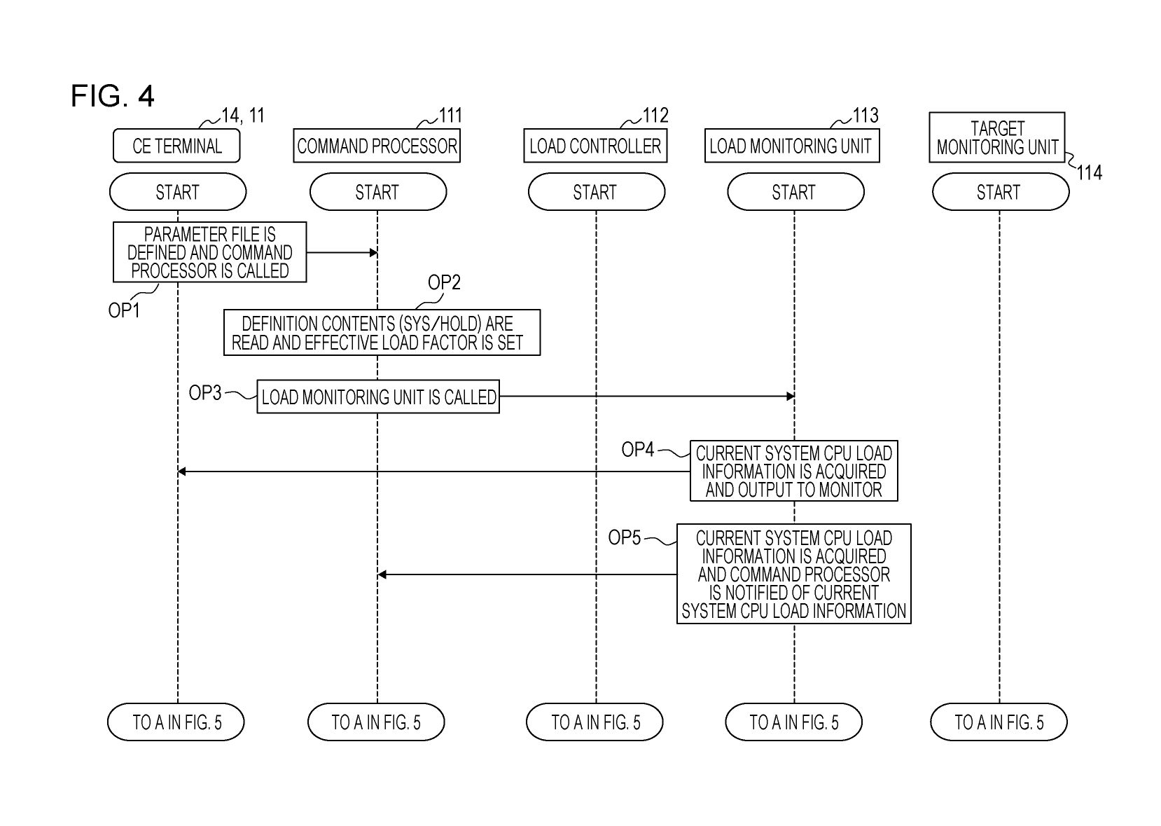

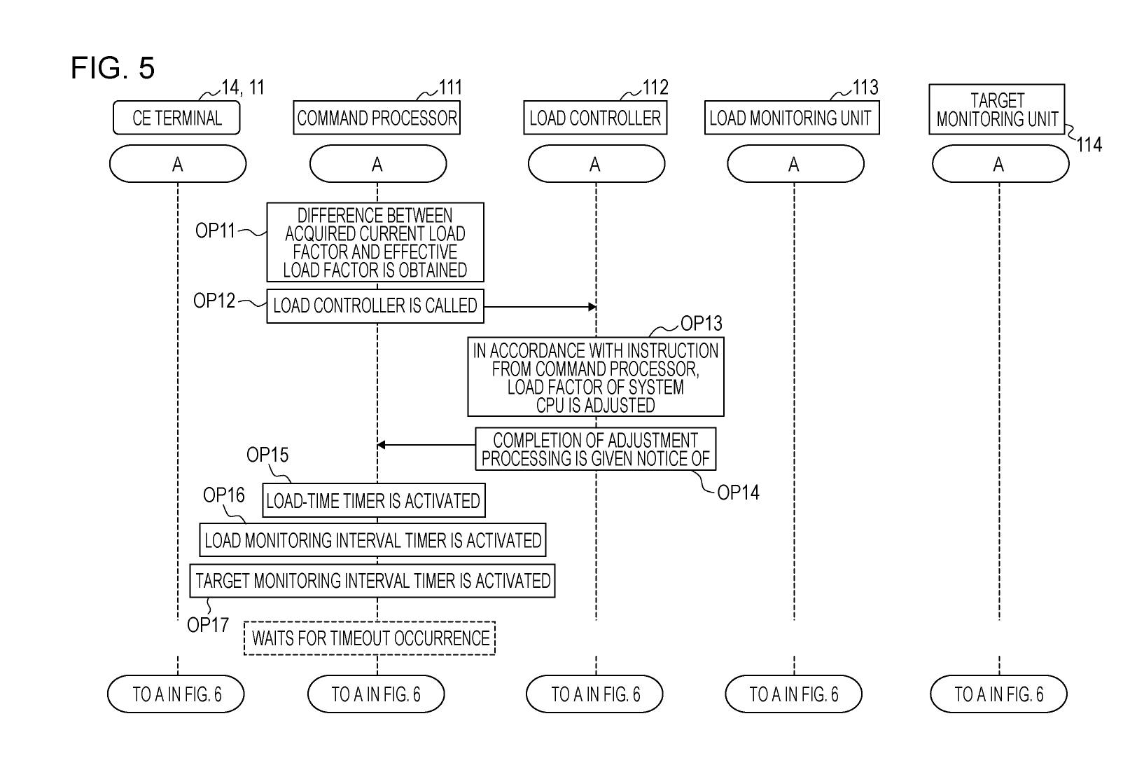

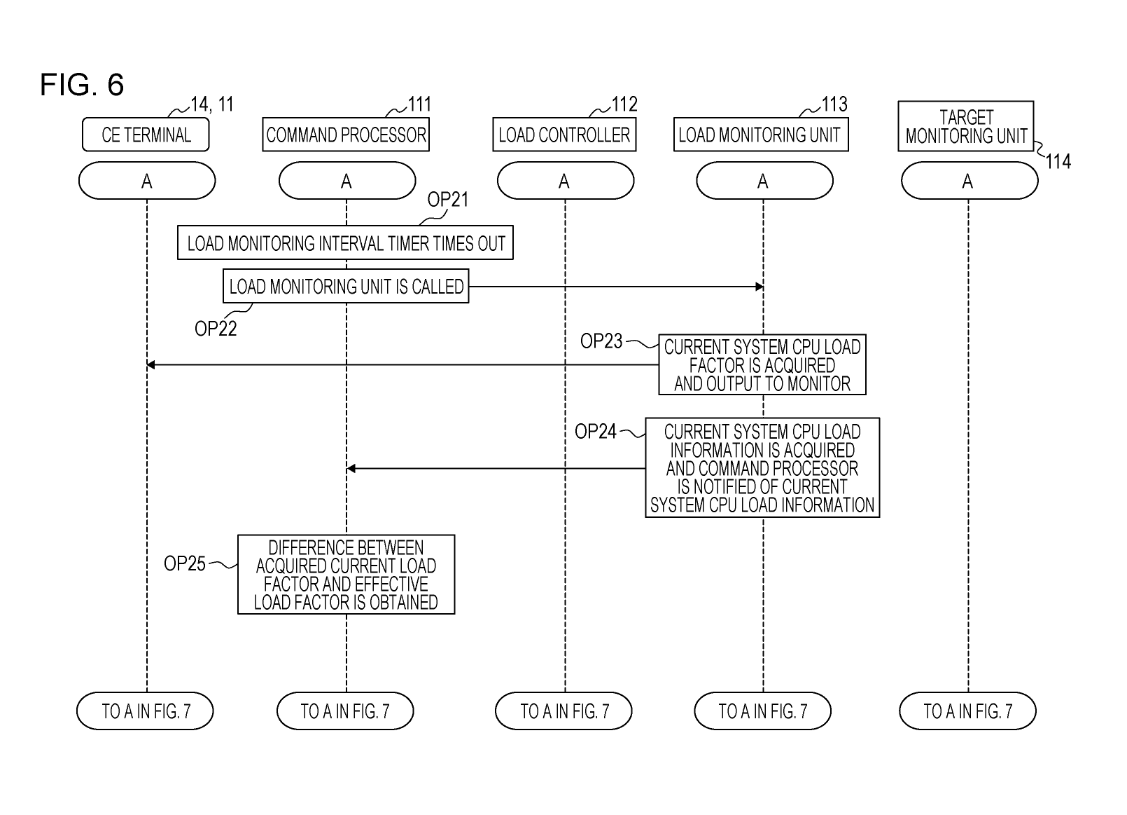

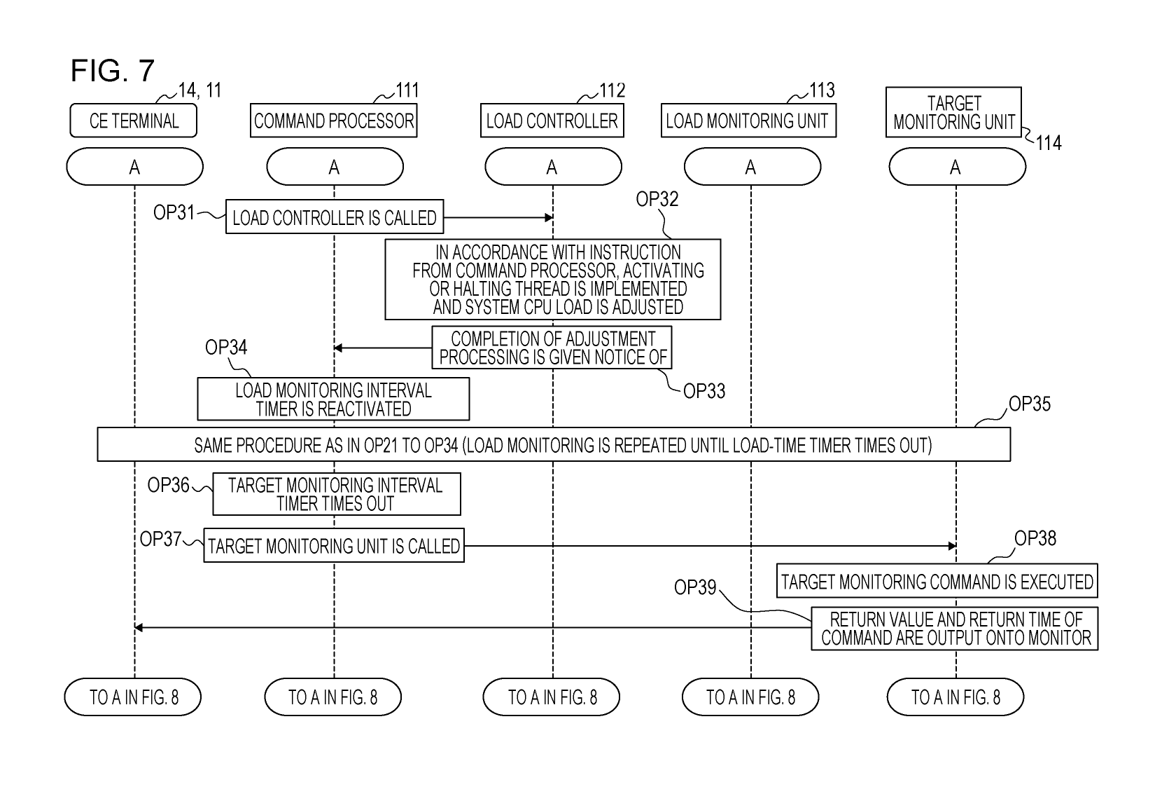

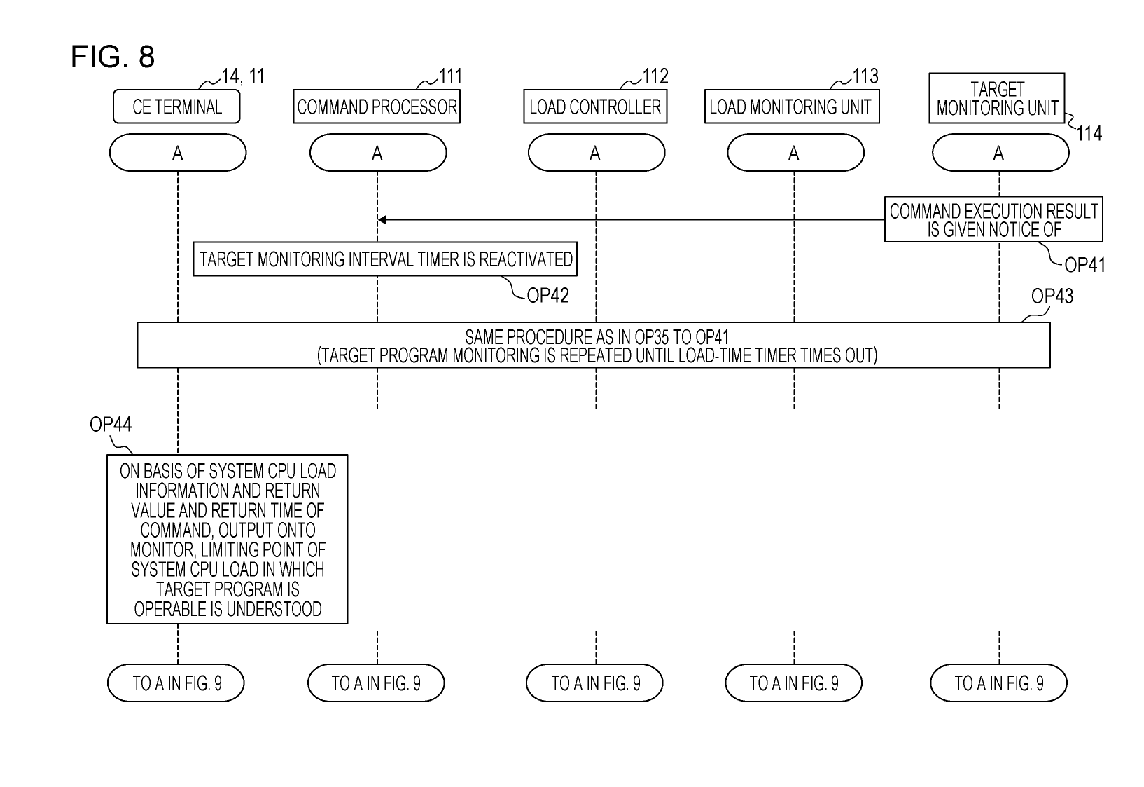

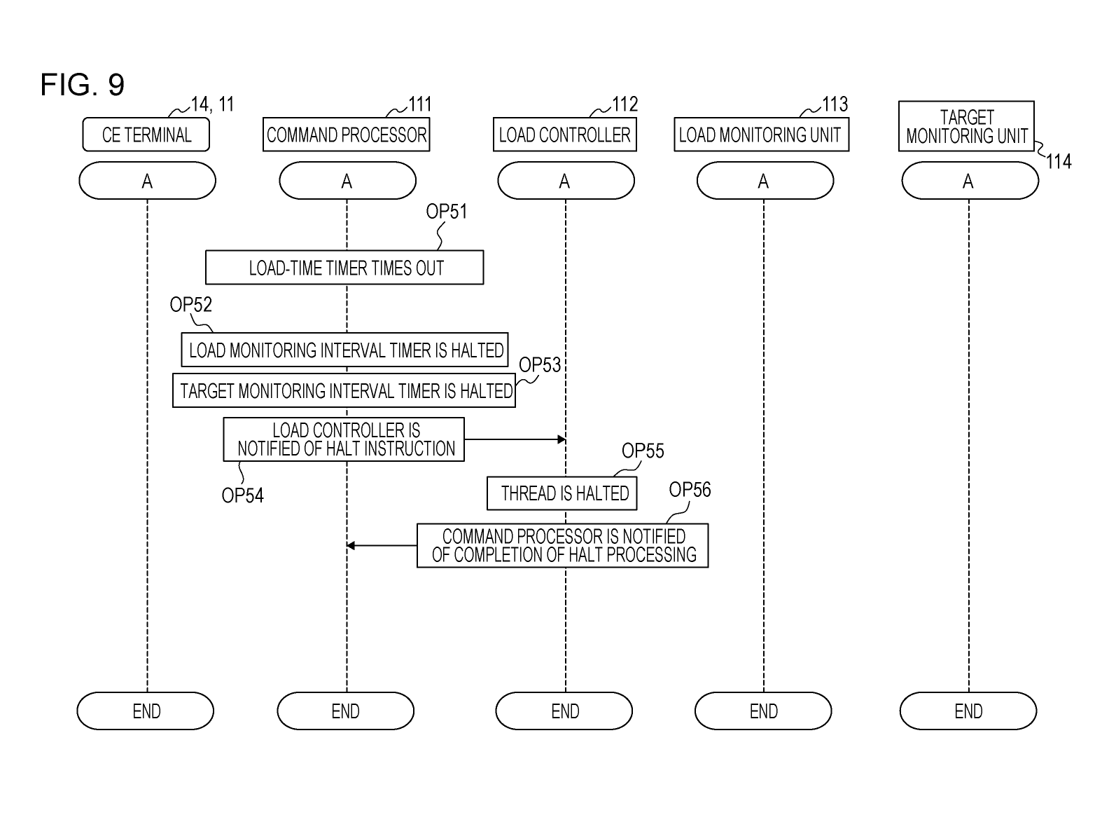

FIG. 4 to FIG. 9 are sequence diagrams illustrating an example of the operation of the load control device 1000A according to the first embodiment. Processing illustrated in FIG. 4 is followed by “A” in FIG. 5. Processing illustrated in FIG. 5 is followed by “A” in FIG. 6. Processing illustrated in FIG. 6 is followed by “A” in FIG. 7. Processing illustrated in FIG. 7 is followed by “A” in FIG. 8. Processing illustrated in FIG. 8 is followed by “A” in FIG. 9. The processing illustrated in FIG. 4 to FIG. 9 indicates processing where, using the CE terminal 14, the CE diagnoses the operating state of the target program 115A, due to the load control device 1000A according to the first embodiment. In the processing illustrated in FIG. 4 to FIG. 9, the CE performs various kinds of instructions and the like, using the CE terminal 14.

As illustrated in FIG. 4, using the CE terminal 14, the CE defines the parameter file 104 in the HDD 103, and calls the command processor 111 (OP1). The command processor 111 reads the load type and the load mode, which serve as the definition contents of the parameter file 104, and sets the effective load factor of the CPU 101 in the system program area illustrated in FIG. 1 and FIG. 2 (OP2). In the parameter file 104 according to FIG. 3, the load type is defined as “SYS”, and the load mode is defined as “HOLD”. Therefore, as the “load factor maximum”, the command processor 111 sets, for example, the load factor of 90% as the effective load factor of the system program area in the CPU 101. The command processor 111 calls the load monitoring unit 113 and acquires the current load factor of the CPU 101 (OP3).

When having received a call from the command processor 111, the load monitoring unit 113 acquires the current CPU load information on the system program area side, and outputs the current CPU load information to the monitor 11 (OP4). The load monitoring unit 113 acquires the current CPU load information of the system program area, and notifies the command processor 111 of the current CPU load information (OP5).

As illustrated in FIG. 5, the command processor 111 obtains a difference between the acquired current load factor of the system program area in the CPU 101 and the set effective load factor (OP11). The command processor 111 calls the load controller 112, and causes the load controller 112 to adjust the load factor of the CPU 101 (OP12).

By executing or halting investing a predetermined thread in the thread execution unit 112A, the load controller 112 adjusts the load factor of the system program area in the CPU 101 (OP13). Specifically, the load controller 112 executes/activates or halts a predetermined thread due to the thread execution unit 112A so as to decrease a difference between the current load factor of the system program area in the CPU 101 and the set effective load factor, and adjusts the load factor of the system program area. After having completed processing for adjusting the load factor of the system program area in the CPU 101, the load controller 112 notifies the command processor 111 of the completion of the load adjustment processing (OP14).

The command processor 111 activates the load-time timer, and starts timing a time when the load controller 112 applies a load onto the CPU 101 in the system program area (OP15). The command processor 111 activates the load monitoring interval timer, and starts timing a time interval when the load monitoring unit 113 monitors the load of the CPU 101 in the system program area (OP16). The command processor 111 activates the target monitoring interval timer, and starts timing a time interval when the target monitoring unit 114 monitors the operating state of the target program 115A in the system program area (OP17). After the processing operation in OP17, the command processor 111 shifts to a mode for waiting the timeout occurrence of the timer 101A.

As illustrated in FIG. 6, when having detected that the load monitoring time has elapsed owing to the timeout of the load monitoring interval timer in the mode for waiting the timeout occurrence of the timer 101A (OP21), the command processor 111 calls the load monitoring unit 113 so as to acquire again, from the load monitoring unit 113, the current load factor of the CPU 101 in the system program area (OP22).

The load factor of the CPU 101 fluctuates owing to the operating state of a program other than the target program 115A. When a load is applied onto the CPU 101 owing to the operation of a program other than the target program 115A, the load factor of the CPU 101 increases. On the other hand, when the operation of a program other than the target program 115A is halted, the load of the CPU 101 is reduced, and hence the load factor of the CPU 101 decreases. In addition, when traffic from another server to the server 100 has increased, the load factor of the CPU 101 fluctuates owing to an increase in the amount of packets transmitted from the other server to the CPU 101. In preparation for the fluctuation of the load factor of the CPU 101, it may be desirable to acquire again the current load factor of the system program area in the CPU 101.

When having a call from the command processor 111, the load monitoring unit 113 acquires again the current load factor of the system program area in the CPU 101, and outputs the acquired current load factor to the monitor 11 (OP23). When having a call from the command processor 111, the load monitoring unit 113 acquires the current load factor of the system program area in the CPU 101, and notifies again the command processor 111 of the acquired load factor of the system program area (OP24).

When having acquired, from the load monitoring unit 113, the current load factor of the system program area in the CPU 101, the command processor 111 obtains again a difference between the acquired current load factor of the system program area in the CPU 101 and the preliminarily set effective load factor (OP25).

As illustrated in FIG. 7, so as to adjust again the load factor of the system program area in the CPU 101 owing to the load controller 112, the command processor 111 calls again the load controller 112 (OP31).

When having received a call from the command processor 111, the load controller 112 adjusts again the load factor of the CPU 101 in the system program area, in the same way as the processing operation in OP13 illustrated in FIG. 5 (OP32). After having completed again the processing for adjusting the load factor of the CPU 101 in the system program area, the load controller 112 notifies again the command processor 111 of the completion of the adjustment processing, in the same way as the processing operation in OP14 illustrated in FIG. 5 (OP33).

When having been notified of the completion of the adjustment processing by the load controller 112, the command processor 111 reactivates the load monitoring interval timer, and resumes timing the time interval when the load monitoring unit 113 monitors the load of the system program area in the CPU 101 (OP34). The above-mentioned processing operations in OP21 to OP34, namely, load monitoring processing, are repeated until the load-time timer times out and hence the elapse of the set time for applying a load onto the CPU 101 is detected (OP35).

When, owing to the timeout of the target monitoring interval timer in the mode for waiting the timeout occurrence of the timer 101A, having detected the elapse of the time for applying a load onto the CPU 101 (OP36), the command processor 111 calls the target monitoring unit 114, and monitors the execution state of the target program 115A (OP37).

When having received a call from the command processor 111, the target monitoring unit 114 executes a target program monitoring command, and executes the monitoring of the target program 115A (OP38). Specifically, for example, by acquiring the return value at the time of the return of a command or by timing a time having elapsed before the return of the command, the target monitoring unit 114 determines the operating state of the target program 115A. The target monitoring unit 114 causes the return value at the time of the return of the command and the time having elapsed before the return of the command to be output to the monitor 11 (OP39). After having output the return value and the time having elapsed before the return to the monitor 11, the target monitoring unit 114 notifies the command processor 111 of the execution result of the command, as illustrated in FIG. 8 (OP41). The operating state of the target program 115A is determined from, for example, the value of the return value (returned value) at the time of the return of the command and the measured time having elapsed before the return of the command. As an example, a case where the value of the “return value (returned value)” is “0” indicates normal termination, and a case of “1” indicates abnormal termination, namely, indicates that an error has occurred.

As illustrated in FIG. 8, when having been notified of a command execution result by the target monitoring unit 114 (OP41), the command processor 111 reactivates the target monitoring interval timer, and resumes timing the time interval when the target program 115A is monitored (OP42).

The above-mentioned processing operations in OP35 to OP41, namely, target program monitoring processing, are repeated until the load-time timer times out and hence the set time for applying a load elapses (OP43).

The output load information of the CPU 101 in the system program area and the return value and the return time of a command according to the target program 115A are output to the monitor 11. Using the CE terminal 14, on the basis of the information output to the monitor 11, it may become possible for the CE to understand the limiting point of the load of the CPU 101 in the system program area in which the target program 115A is operable (OP44).

As illustrated in FIG. 9, when, owing to the timeout of the load-time timer in the mode for waiting the timeout occurrence of the timer 101A, having detected the elapse of the set time for applying a load, the command processor 111 causes timing the load-time timer to be halted (OP51) and forcibly causes timing the load monitoring interval timer to be halted (OP52). In the same way, the command processor 111 forcibly causes timing the target monitoring interval timer to be halted (OP53). The command processor 111 notifies the load controller 112 of an instruction for halting the thread or threads (OP54).

When, by the command processor 111, having been notified the load controller 112 of an instruction for halting the thread or threads, the load controller 112 causes all threads to be halted, the threads being invested in the thread execution unit 112A in the CPU 101 so as to apply a load (OP55). After processing for halting the load controller 112 has been completed, the load controller 112 notifies the command processor 111 of the completion of the halt processing (OP56). Owing to the processing operation in OP56, the repetition of the above-mentioned processing operations in OP34 to OP41 is terminated.

According to the load control device 1000A, the load control method, and the load control program according to the first embodiment, the effective load factor of the system program area in the CPU 101 is set, a difference between the effective load factor of the CPU 101 and the current load factor is obtained, and activating a thread and halting a thread are performed. By performing activating a thread and halting a thread, an increase and a decrease in the load factor of the CPU 101 are performed, and the fluctuation of the load factor is suppressed. Therefore, it may be possible to correctly measure the load factor of the CPU 101 when the target program 115A is caused to operate. In addition, it may be possible to correctly measure the load factor of the CPU 101 when the target program 115A is caused to operate in the kernel space.

### Second Embodiment

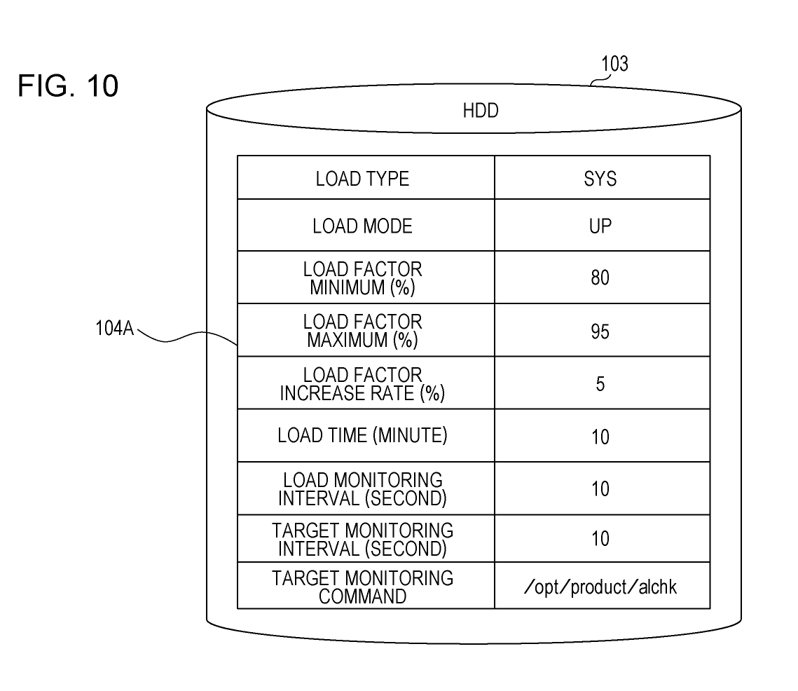

In FIG. 10 to FIG. 17, the load control device 1000A, the load control method, and the load control program according to the second embodiment will be described. In addition, in the second embodiment, the same symbol will be assigned to the same configuration as the configuration described in the first embodiment, and the description thereof will be omitted. Furthermore, since the configuration of each of the server 100 according to the second embodiment and the load control device 1000A of the second embodiment is the same as in FIG. 1 and FIG. 2, the description thereof will be omitted.

According to the load control device 1000A, the load control method, and the load control program according to the second embodiment, after the load factor of the system program area in the CPU 101 has been maintained for a given period of time, a predetermined load factor is added to the maintained load factor of the system program area in the CPU 101. In the same way as in the first embodiment, the load factor of the CPU 101, to which the predetermined load factor has been added, is maintained for a given period of time, and load control for the target program 115A operating in the system program area is performed. Therefore, it may be possible to measure, in a stepwise fashion, the load factor of the CPU 101 when the target program 115A is caused to operate in the system program area.

FIG. 10 is a diagram illustrating a portion of a parameter file 104A according to the second embodiment. The parameter file 104A is stored in the HDD 103 illustrated in FIG. 1 and FIG. 2.

The load type is an item used for setting onto which of the system program area and the user program area the load controller 112 applies a load, in the CPU 101. In the load control device 1000A according to the second embodiment, “SYS” is input that indicates a setting for applying a load onto the system program area side.

The load mode is an item used for setting how to apply a load when the load controller 112 according to the FIG. 2 applies a load onto the CPU 101. In the load control device 1000A according to the second embodiment, “UP” is input in the load mode.

When the load mode is “UP”, the load control device 1000A adds the load factor increase rate (%) to the load factor minimum (%) in a stepwise fashion and applies a load onto the CPU 101 only for a time set as the load time (minute), in the same way as described in FIG. 3 in the first embodiment. In some cases, there occurs a case where the value of the effective load factor after the addition of the load factor increase rate, obtained by adding the load factor increase rate (%) to the load factor minimum (%) in a stepwise fashion, becomes a value larger than the load value maximum (%). In the case where the value of the effective load factor becomes a value larger than the load value maximum (%), the load control device 1000A halts processing for adding, in a stepwise fashion, the load factor increase rate (%) to the effective load factor after the addition of the load factor increase rate. At the same time, the load control device 1000A calls the load controller 112 using the command processor 111, and notifies the load controller 112 of an instruction for halting the activation of the thread of the thread execution unit 112A.

In the parameter file 104A according to the second embodiment, the load factor minimum (%) is set to 80(%). In the parameter file 104A according to the second embodiment, the load factor maximum (%) is set to 95(%). In the parameter file 104A according to the second embodiment, the load factor increase rate is set to 5(%). In the parameter file 104A according to the second embodiment, the load time is set to 10 minutes.

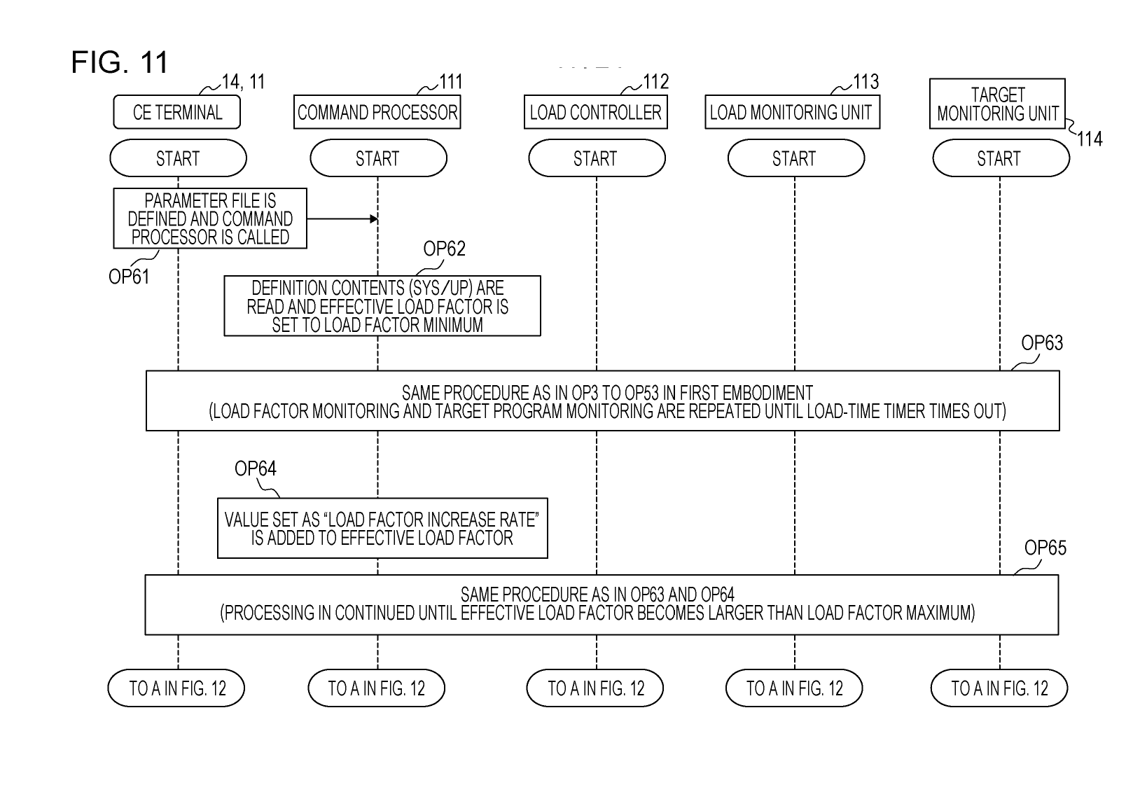

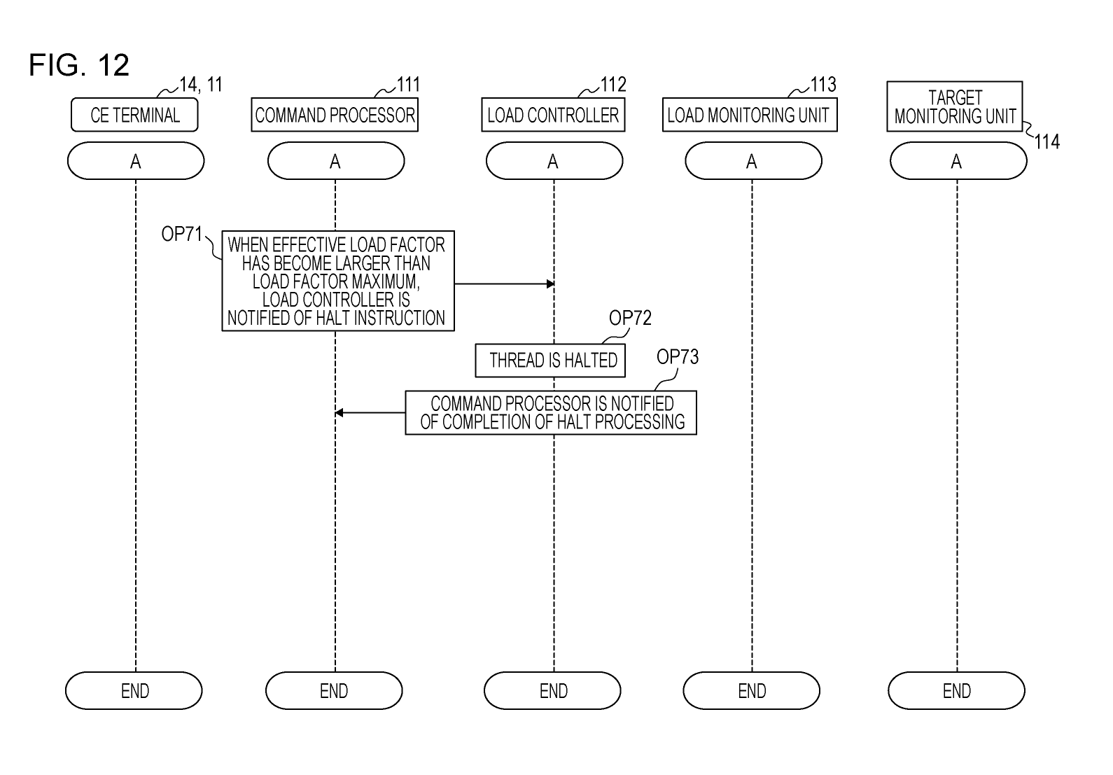

FIG. 11 and FIG. 12 are sequence diagrams illustrating an example of the operation of the load control device 1000A according to the second embodiment. Processing illustrated in FIG. 11 is followed by “A” in FIG. 12. The processing illustrated in FIG. 11 and FIG. 12 indicates processing when, using the CE terminal 14, the CE executes load control for the target program 115A with using the load control device 1000A according to the second embodiment.

As illustrated in FIG. 11, using the CE terminal 14, the CE defines the parameter file 104A, and calls the command processor 111 (OP61). The command processor 111 reads “SYS” and “UP”, which serve as the definition contents of the second embodiment, and sets the effective load factor on the system program side in the CPU 101 illustrated in FIG. 1 and FIG. 2 (OP62). In the parameter file 104A according to FIG. 11, the load type is defined as “SYS”, and the load mode is defined as “UP”. Therefore, the command processor 111 sets, for example, 80% set in the “load factor minimum”, as the effective load factor on the system program side in the CPU 101.

In addition, in the second embodiment, in a state of being set as 80% serving as the “load factor minimum”, the effective load factor on the system program side in the CPU 101 is maintained for 10 minutes serving as the “load time”. Next, only 5% serving as the “load factor increase rate” is added to the effective load factor on the system program side in the CPU 101, and maintained for 10 minutes serving as the “load time”. Only 5% serving as the “load factor increase rate” is repeatedly added to the effective load factor on the system program side in the CPU 101, and the effective load factor on the system program side in the CPU 101 is increased up to 95% serving as the “load factor maximum”, in a stepwise fashion.

In the command processor 111, after the processing operation in OP62, the same processing operations as in OP3 to OP53 in the first embodiment are performed (OP63). In other words, in the same way as in the first embodiment, the load factor monitoring processing for the CPU 101 and the monitoring processing for the target program 115A are performed until the load monitoring timer times out and a time for monitoring a load applied onto the CPU 101 elapses.

The command processor 111 adds, to the current effective load factor, a value set as the load factor increase rate of the parameter file 104A (OP64). The above-mentioned processing operations in OP63 to OP64 are repeated until the effective load factor becomes larger than the load factor maximum (OP65).

As illustrated in FIG. 12, when the effective load factor has become larger than the load factor maximum, the command processor 111 notifies the load controller 112 of an instruction for halting a thread activated in the load controller 112 (OP71).

When, by the command processor 111, having been notified of an instruction for halting the load controller 112, the load controller 112 causes a running thread to be halted, the thread being invested so as to apply a load in the CPU 101 (OP72). After processing for halting a thread in the load controller 112 has been completed, the load controller 112 notifies the command processor 111 of the completion of the halt processing for a thread (OP73).

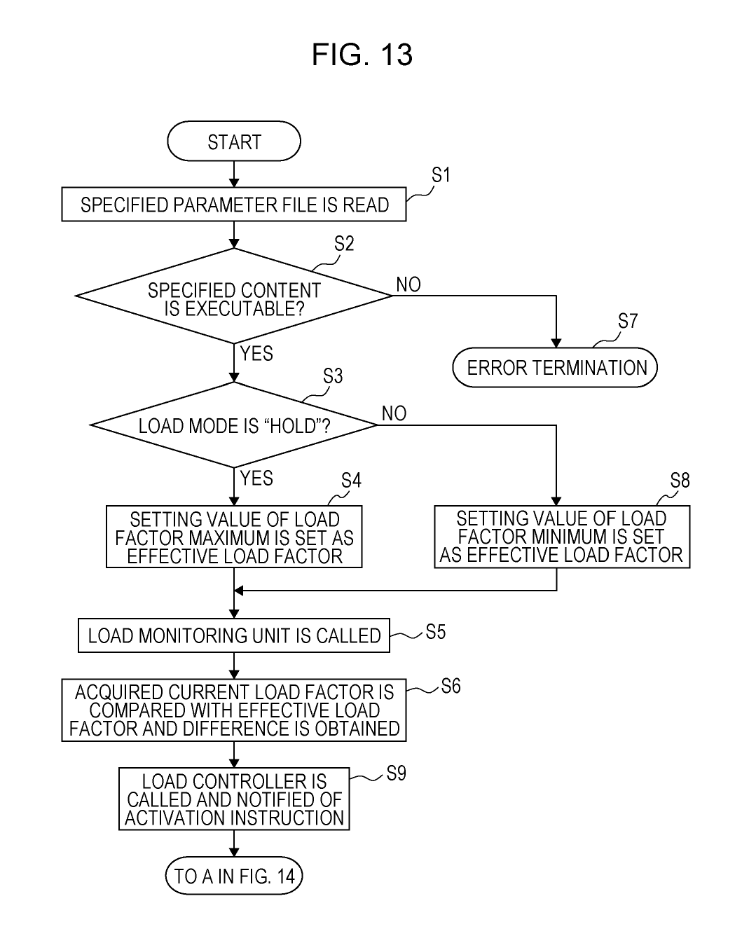

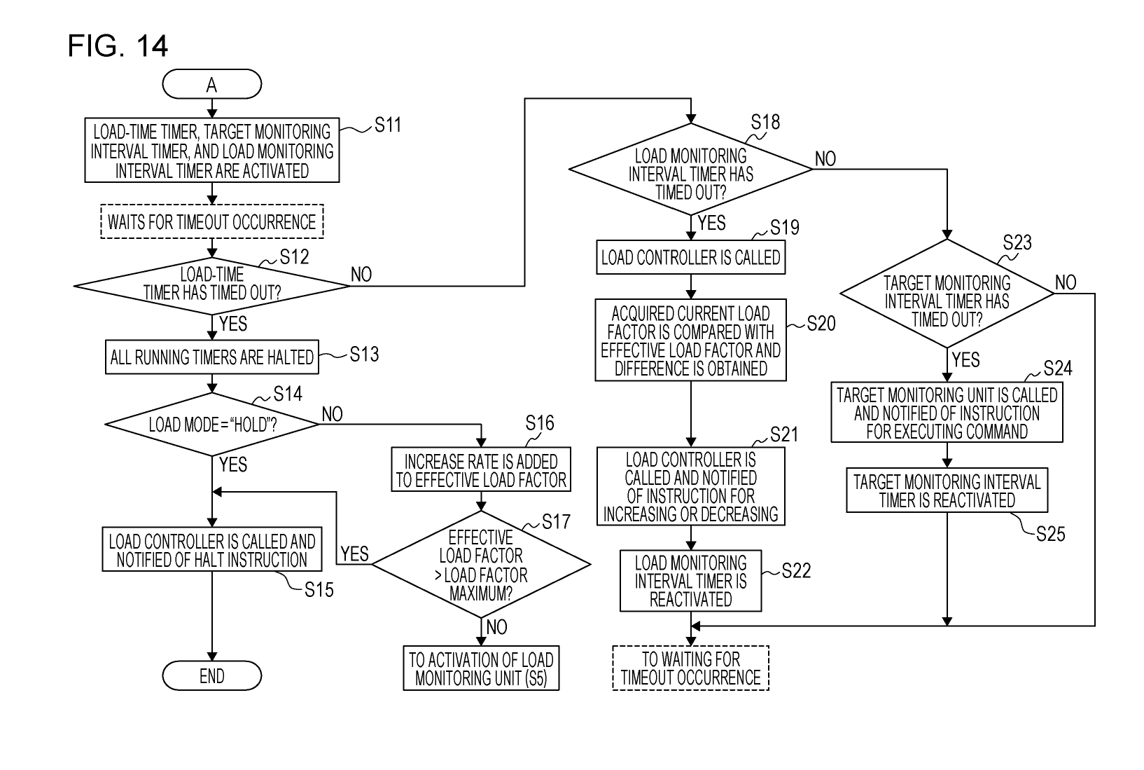

FIG. 13 and FIG. 14 are diagrams illustrating flowcharts illustrating the operation of the command processor 111 according to the first embodiment and the second embodiment. Processing illustrated in FIG. 13 is followed by “A” in FIG. 14. The flowcharts of the command processor 111 illustrated in FIG. 13 and FIG. 14 correspond to the sequence diagrams illustrating an example of the operation of the command processor 111, from among the sequence diagrams illustrating an example of the operation of the load control device 1000A, illustrated in FIG. 4 to FIG. 9.

As illustrated in FIG. 13, in S1, the command processor 111 reads the parameter file 104 specified by the input-output command processor 111A (OP2 in FIG. 4).

In S2, the command processor 111 determines whether the specified content of each parameter in the parameter file 104 is executable. When, in S2, it has been determined that the specified content of each parameter is executable, next the command processor 111 performs determination in S3.

In S3, the command processor 111 determines the load mode specified by the parameter file 104. When, in S3, it has been determined that load mode is “HOLD”, next the command processor 111 performs a processing operation in S4.

In S4, the command processor 111 sets, for example, the setting value of the load factor maximum in the CPU 101 as the effective load factor of the CPU 101.

In S5, the command processor 111 calls the load monitoring unit 113 (OP3 in FIG. 4).

In S6, the command processor 111 compares the acquired current load factor with the set effective load factor, and obtains a difference (OP11 in FIG. 5).

In S9, so as to cause the called load controller 112 to adjust the load factor of the CPU 101 on the system program side, the command processor 111 instructs to activate or halt a thread due to the thread execution unit 112A (OP12 in FIG. 5).

As illustrated in FIG. 14, in S11, the command processor 111 activates the load-time timer, the load monitoring interval timer, and the target monitoring interval timer, and individually starts timing the time for applying a load onto the CPU 101, the load monitoring interval time, and the target monitoring interval time (OP15, OP16, and OP17 in FIG. 5). After the processing operation in S11, the command processor 111 shifts to the mode for waiting the timeout occurrence of the timer 101A.

In S12, the command processor 111 determines whether the load-time timer has timed out (OP21 in FIG. 6). When the load-time timer has timed out, the command processor 111 performs a processing operation in S13.

In S13, the command processor 111 causes all of the load-time timer, the load monitoring interval timer, and the target monitoring interval timer, which are running (OP51, OP52, and OP53 in FIG. 9).

In S14, in the same way as in S3 in FIG. 13, the command processor 111 determines the load mode specified by the parameter file 104. When, in S14, it has been determined that the load mode is “HOLD”, next the command processor 111 perform a processing operation in S15.

In S15, the command processor 111 calls the load controller 112, and notifies the load controller 112 of an instruction for halting the activation of the thread of the thread execution unit 112A (OP54 in FIG. 9).

In addition, in S2 illustrated in FIG. 13, the command processor 111 confirms the specified content of each parameter, and when having determined that the parameter is not executable, the command processor 111 performs error termination processing in S7. For example, when the command processor 111 has failed to read each parameter in the parameter file 104, it may be difficult for the command processor 111 to execute a parameter. In addition, for example, when the command processor 111 has specified a character string not defined in the parameter file 104, it may be difficult for the command processor 111 to execute a parameter. In addition, for example, when the command processor 111 has specified a numerical value out of an acceptable range in the parameter file 104, it may be difficult for the command processor 111 to execute a parameter. In addition, for example, when there is a discrepancy between the setting values of parameters in the parameter file 104, it may be difficult for the command processor 111 to execute a parameter. In addition, for example, when a specified command does not exist in the parameter file 104, it may be difficult for the command processor 111 to execute a parameter.

In addition, in S3 illustrated in FIG. 13, in some cases there occurs a case where the command processor 111 determines that the load mode is not “HOLD”. In other words, when the command processor 111 has determined that the load mode is an “UP” mode described later in the second embodiment, in S8 the setting value of the load factor minimum of the CPU 101 in the system program area is set as the effective load factor of the CPU 101 (OP62 in FIG. 11).

In addition, when, in S12 illustrated in FIG. 14, the command processor 111 determines that the load-time timer does not time out, the command processor 111 proceeds to a processing operation in S18. In S18, the command processor 111 determines whether the load monitoring interval timer has timed out. When, in S18, it has been determined that the load monitoring interval timer has timed out, next the command processor 111 performs a processing operation in S19.

In S19, the command processor 111 calls the load monitoring unit 113 (OP22 in FIG. 6). When having received a call from the command processor 111, the load monitoring unit 113 acquires again the current load factor of the system program area in the CPU 101, and outputs the acquired current load factor to the monitor 11 (OP23 in FIG. 6). When having received a call from the command processor 111, the load monitoring unit 113 acquires the current load factor of the system program area in the CPU 101, and notifies again the command processor 111 of the acquired load factor of the system program area (OP24 in FIG. 6).

In S20, the command processor 111 compares the acquired current load factor with the set effective load factor, and obtains a difference (OP25 in FIG. 6).

In S21, the command processor 111 calls the load controller 112, causes the load controller 112 to activate or halt a predetermined thread for the thread execution unit 112A, and gives notice of an instruction for increasing or decreasing the load factor of the system program area in the CPU 101 (OP31 in FIG. 7). In other words, the command processor 111 gives notice of an instruction for adjusting the load factor of the system program area in the CPU 101 owing to the load controller 112.

In S22, by reactivating the load monitoring interval timer, the command processor 111 restarts timing the load monitoring time (OP34 in FIG. 7). When the processing operation in S22 has been terminated, the command processor 111 shifts to the mode for waiting the timeout occurrence of the timer 101A.

In addition, when, in S18, it has been determined that the load monitoring interval timer has not timed out, in S23 the command processor 111 determines whether the target monitoring interval timer has timed out. When, in S23, it has been determined that the target monitoring interval timer has timed out, next the command processor 111 performs a processing operation in S24.

In S24, the command processor 111 calls the target monitoring unit 114, and notifies the target monitoring unit 114 of an instruction for causing the target monitoring command of the target program 115A to be executed.

In S25, by reactivating the target monitoring interval timer, the command processor 111 resumes timing the target monitoring interval time (OP42 in FIG. 8). After the processing operation in S25, the command processor 111 shifts to the mode for waiting the timeout occurrence of the timer 101A.

In addition, in some cases, there occurs a case where, in S14, the command processor 111 determines that the load mode is not “HOLD” and is the “UP” mode in the second embodiment. In this case, in S16, the command processor 111 adds the load factor increase rate set in the parameter file 104 to the effective load factor of the system program area in the CPU 101, and sets a result obtained by the addition, as an effective load factor (hereinafter, referred to as an “effective load factor after the addition of the load factor increase rate”) (OP62 in FIG. 11).

In S17, the command processor 111 determines whether the current effective load factor after the addition of the load factor increase rate in the system program area in the CPU 101 is a value larger than the load factor maximum set in the parameter file 104. When the effective load factor of the CPU 101 is less than or equal to the load factor maximum, the command processor 111 shifts to a processing operation for activating the load monitoring unit 113, performed in S5 in FIG. 13 (OP64 in FIG. 11). When, in S17, the effective load factor after the addition of the load factor increase rate in the CPU 101 is a value larger than the load factor maximum, the command processor 111 shifts to a processing operation in S15.

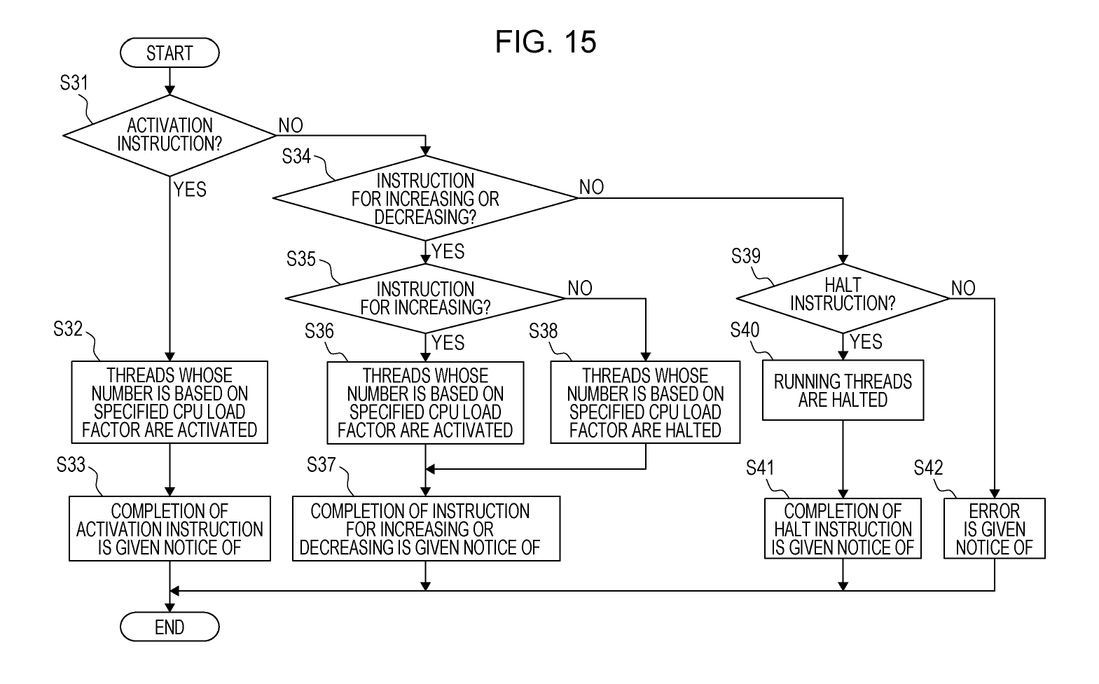

FIG. 15 is a diagram illustrating a flowchart illustrating the operation of the load controller 112 according to the first embodiment and the second embodiment. The flowchart of the load controller 112 illustrated in FIG. 15 corresponds to the sequence diagrams illustrating an example of the operation of the load controller 112, from among sequence diagrams illustrating an example of the operation of the load control device 1000A, illustrated in FIG. 4 to FIG. 9.

In S31, the load controller 112 determines whether the command processor 111 has given notice of an activation instruction. When, in S31, having determined that the command processor 111 has given notice of an activation instruction, next the load controller 112 performs a processing operation in S32.

In S32, the load controller 112 invests threads in the thread execution unit 112A, where the number of the threads is based on the load factor of the CPU 101, specified by the command processor 111, and hence, activates the threads (OP13 in FIG. 5). In addition, the thread is the executable unit of a dummy program. The load controller 112 invests, in the thread execution unit 112A, threads whose number is based on the load factor of the CPU 101, and hence, the dummy program operates. When the dummy program has operated, the load factor of the CPU 101 increases. Therefore, when the load controller 112 invests, in the thread execution unit 112A, threads whose number is based on the load factor of the CPU 101, the load factor of the CPU 101 increases.

In S33, the load controller 112 notifies the command processor 111 of the completion of the thread activation processing (OP14 in FIG. 5).

In addition, when, in S31, having determined that the command processor 111 has not given notice of the instruction for activating a thread, in S34 the load controller 112 determines whether the load controller 112 has received, from the command processor 111, an instruction for increasing or decreasing the number of threads serving as targets to be started. When, in S34, having determined that the command processor 111 has given notice of the instruction for increasing or decreasing the number of threads serving as targets to be started, next the load controller 112 performs determination in S35.

In S35, the load controller 112 determines whether the command processor 111 has given notice of the instruction for increasing the number of threads serving as targets to be started. When, in S35, having determined that the command processor 111 has given notice of the instruction for increasing the number of threads serving as targets to be started, next the load controller 112 performs a processing operation in S36.

In S36, the load controller 112 invests, in the thread execution unit 112A, threads whose number is based on the load factor of the CPU 101 specified by the command processor 111, and hence, activates the threads (OP13 in FIG. 5).

In S37, the load controller 112 notifies the command processor 111 of the completion of the instruction for increasing or decreasing the number of the threads serving as targets to be started, the number being based on the load factor of the CPU 101 (OP14 in FIG. 5).

In addition, when, in S35, having determined that the command processor 111 has not given notice of the instruction for increasing the number of threads serving as targets to be started, next the load controller 112 performs a processing operation in S38.

In S38, the load controller 112 instructs to cause the thread execution unit 112A to halt threads whose number is based on the load factor of the CPU 101 specified by the command processor 111 (OP13 in FIG. 5). After the termination of the processing operation in S38, the load controller 112 performs a processing operation in S37.

In addition, when, in S34, having determined that the command processor 111 has not given notice of the instruction for increasing or decreasing the number of threads serving as targets to be started, next the load controller 112 performs a processing operation in S39.

In S39, the load controller 112 determines whether the command processor 111 has given notice of an instruction for halting a thread. When, in S39, having determined that the command processor 111 has given notice of a halt instruction, next the load controller 112 performs a processing operation in S40.

In S40, the load controller 112 halts a running thread invested in the CPU 101 so as to apply a load in the CPU 101 (OP13 in FIG. 5).

In S41, the load controller 112 notifies the command processor 111 of the completion of the halt instruction (OP14 in FIG. 5).

In addition, when, in S39, having determined that the command processor 111 has not given notice of the halt instruction, next the load controller 112 performs a processing operation in S42.

In S42, since the kind of an instruction given notice of by the command processor 111 has not been an instruction recognized in the load controller 112, the load controller 112 notifies the command processor 111 of an error.

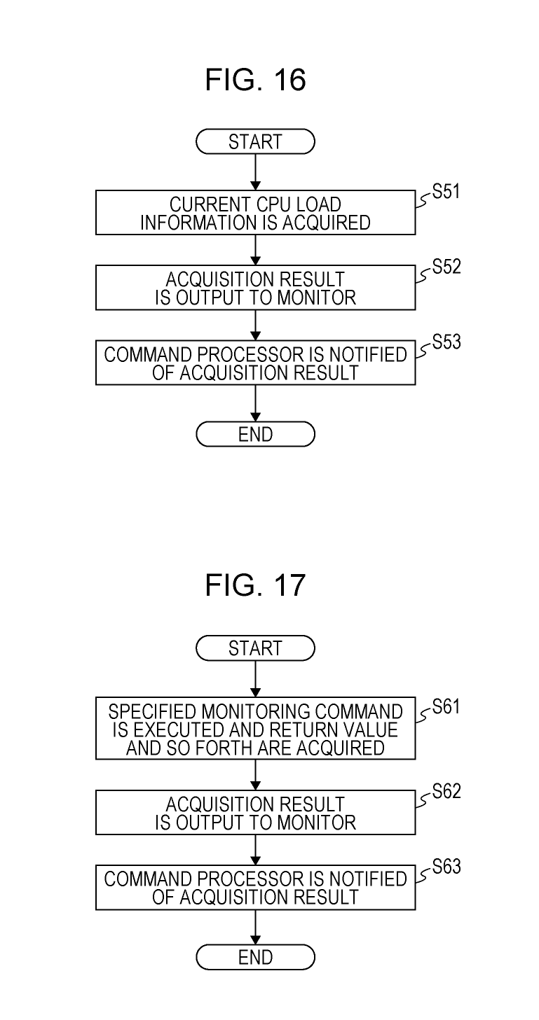

FIG. 16 is a diagram illustrating a flowchart illustrating the operation of the load controller 113 according to the first embodiment and the second embodiment. The flowchart of the load monitoring unit 113 illustrated in FIG. 16 corresponds to the sequence diagrams illustrating an example of the operation of the load monitoring unit 113, from among the sequence diagrams illustrating an example of the operation of the load control device 1000A, illustrated in FIG. 4 to FIG. 9.

In S51, when having received a call from the command processor 111, the load monitoring unit 113 acquires the current load information of the CPU 101 (OP4 in FIG. 4). The load information of the CPU 101 includes, for example, the load factor of the CPU 101.

In S52, the load monitoring unit 113 outputs, to the monitor 11, the acquisition result of the current load information of the CPU 101 (OP4 in FIG. 4).

In S53, the load monitoring unit 113 notifies the command processor 111 of the acquisition result of the current load information of the CPU 101 (OP5 in FIG. 4).

FIG. 17 is a diagram illustrating a flowchart illustrating the operation of the target monitoring unit 114 according to the first embodiment and the second embodiment. The flowchart of the target monitoring unit 114 illustrated in FIG. 17 corresponds to the sequence diagrams illustrating an example of the operation of the target monitoring unit 114, from among the sequence diagrams illustrating an example of the operation of the load control device 1000A, illustrated in FIG. 4 to FIG. 9.

In S61, when having received a call from the command processor 111, the target monitoring unit 114 executes the target program monitoring command used for executing the monitoring of the target program 115A (OP38 in FIG. 7). For example, by acquiring the return value at the time of the return of a command and by timing a time having elapsed before the return of the command, the target monitoring unit 114 acquires the operating state of the target program 115A.

As for a result obtained by executing the target program monitoring command in S61, two types of results exist that include normal termination and abnormal termination. Using the acquired return value of the command, it may be possible to confirm the result obtained by executing the target program monitoring command. In addition, when the target program monitoring command has been executed in a state where the load factor of the CPU 101 is high, in some cases there occurs a case where a time having elapsed from the execution of the command before the return thereof becomes large with normal termination achieved. When the time having elapsed from the execution of the command before the return thereof is greater than or equal to, for example, 60 seconds, the CE determines that a command return time is not tolerated in the actual operation of the server 100, and determines the command as an error. The CE acquires the operating state of the target program 115A on the basis of the return value and the elapsed time at the time of the return of the command, and determines whether or not the operation of the target program 115A in the load factor of the CPU 101 is allowable.

In S62, the target monitoring unit 114 outputs, to the monitor 11, the acquisition result including the current return value and the time having elapsed before the return (OP39 in FIG. 7).

In S63, the target monitoring unit 114 notifies the command processor 111 of the acquisition result including the current return value and the time having elapsed before the return (OP41 in FIG. 8).

According to the load control device 1000A, the load control method, and the load control program according to the second embodiment, after the load factor on the system program side in the CPU 101 has been maintained for a given period of time, a predetermined load factor is applied on the system program side in the CPU 101. In a state where the predetermined load factor is applied on the system program side in the CPU 101, the load factor on the system program side in the CPU 101 is maintained for a given period of time, in the same way as in the first embodiment. In addition, in the same way as in the first embodiment, the load control for the target program 115A on the system program side in the CPU 101 is performed. Therefore, it may be possible to measure the load factor of the CPU 101 in a stepwise fashion when the target program 115A is caused to operate on the system program side in the CPU 101.

### Third Embodiment

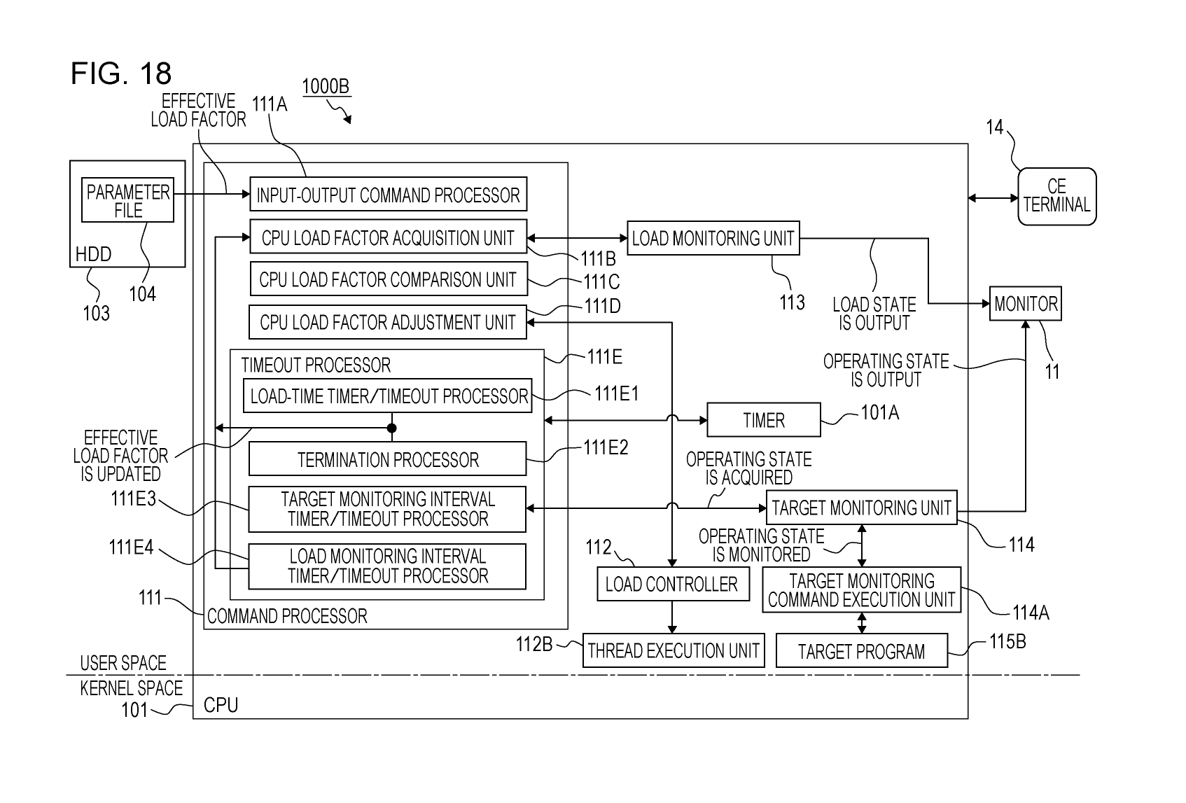

In FIG. 18 to FIG. 25, a load control device 1000B, a load control method, and a load control program according to the third embodiment will be described. In addition, in the third embodiment, the same symbol will be assigned to the same configuration as the configuration described in the first embodiment or the second embodiment, and the description thereof will be omitted. Furthermore, since the configuration of the server 100 according to the third embodiment is the same as in FIG. 1, the description thereof will be omitted.

According to the load control device 1000B, the load control method, and the load control program according to the third embodiment, the effective load factor of the user program area in the CPU 101 is set, a difference between the effective load factor of the CPU 101 and the current load factor is obtained, and activating a thread and halting a thread are performed. By performing activating a thread and halting a thread, the load factor of the CPU 101 is increased and decreased, and the fluctuation of the load factor is suppressed. Therefore, it may be possible to accurately measure the load factor of the CPU 101 when a target program 115B is caused to operate. In addition, it may be possible to accurately measure the load factor of the CPU 101 when the target program 115B is caused to operate in the user space.

FIG. 18 is a diagram illustrating the summary of the load control device 1000B according to the third embodiment. The load control device 1000B is one of functions executed within the server 100. The load control device 1000B includes functions as the command processor 111, the load controller 112, the load monitoring unit 113, and the target monitoring unit 114, included in the CPU 101. In the third embodiment, the target program 115B and a thread execution unit 112B exist in the user space. The user space is, for example, the space of the CPU 101, used by an application program.

When having acquired, from the CPU load factor adjustment unit 111D, a request to increase or decrease the load factor of the CPU 101, the load controller 112 executes or halts investing a thread in the thread execution unit 112B, and hence, causes a load applied to the user program area to be increased or decreased. When having acquired a halt request from the termination processor 111E2, the load controller 112 halts the execution of a thread due to the thread execution unit 112B.

When the target monitoring unit 114 has acquired, from the target monitoring interval timer/timeout processor 111E3, a request to acquire the operating state of the target program 115B, the target monitoring unit 114 monitors the operating state of the target program 115B operating in the user program area of an application program or the like executed in the user space. The target program 115B according to the third embodiment is executed in, for example, the user space. The target monitoring unit 114 activates, for example, a command used for target monitoring, preliminarily set in a “target monitoring command” of the parameter file 104 described later. The target monitoring command execution unit 114A executes the “target monitoring command” activated by the target monitoring unit 114, and monitors the operating state of the target program 115B.

The operating state of the target program 115B is determined on the basis of, for example, the value of a return value (returned value) at the time of the return of a command and a measured time having elapsed before the return of the command. As an example, a case where the value of the “return value (returned value)” is “0” indicates a normal operation, and a case of “1” indicates that an error has occurred. When the time having elapsed before the return of the command is greater than or equal to, for example, 60 seconds, the CE determines that a command return time is not tolerated in the actual operation of the server 100, and determines as an error. Upon receiving an operating-state-acquisition state from the target monitoring command execution unit 114B, the target monitoring unit 114 gives notice of the operating state of the target program 115B, acquired by the target monitoring interval timer/timeout processor 111E3. In addition, the target monitoring unit 114 outputs, to the monitor 11, the acquired operating state of the target program 115B.

The target program 115B is a program to be a target for monitoring in the load control device 1000B according to the third embodiment. The target program 115B according to the third embodiment is executed in, for example, the user space.

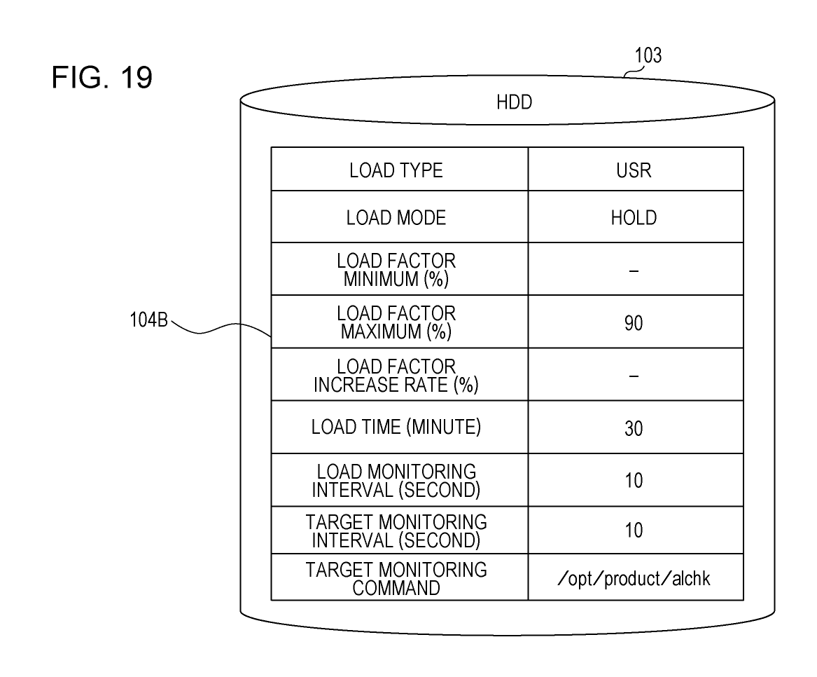

FIG. 19 is a diagram illustrating a portion of a parameter file 104B according to the third embodiment. The parameter file 104B is stored in the HDD 103 illustrated in FIG. 1 and FIG. 2.

The load type is an item used for setting onto which of the CPU 101 of the system and the CPU 101 of the user the load controller 112 according to FIG. 18 applies a load. In the load control device 1000B according to the third embodiment, “USR” is input that indicates a setting for applying a load on the user program area side of the CPU 101.

The load type is an item used for setting in which of the system program area operating in the kernel space and the user program area operating in the user space, from among the address space of the OS executed by the CPU 101, the load controller 112 according to FIG. 19 invests a thread in the thread execution unit 112B in the CPU 101 so as to apply a load. In the load control device 1000B according to the third embodiment, “USR” is input that indicates a setting for applying a load on the user program area side of the CPU 101 by executing the thread execution unit 112B serving as a thread on the user program area side.

The load mode is an item used for setting how to apply a load owing to the execution of the thread of the thread execution unit 112B when the load controller 112 according to the FIG. 18 applies a load onto the CPU 101. In the load control device 1000B according to the third embodiment, “HOLD” is input that indicates that a fixed load set in the load factor maximum (%) is to be applied onto the CPU 101 owing to the execution of the thread of the thread execution unit 112B. When the load mode is “HOLD”, the items of the load factor minimum (%) and the load factor increase rate (%) are not set or values set therein are ignored, in the same way as in the load control device 1000A according to the first embodiment.

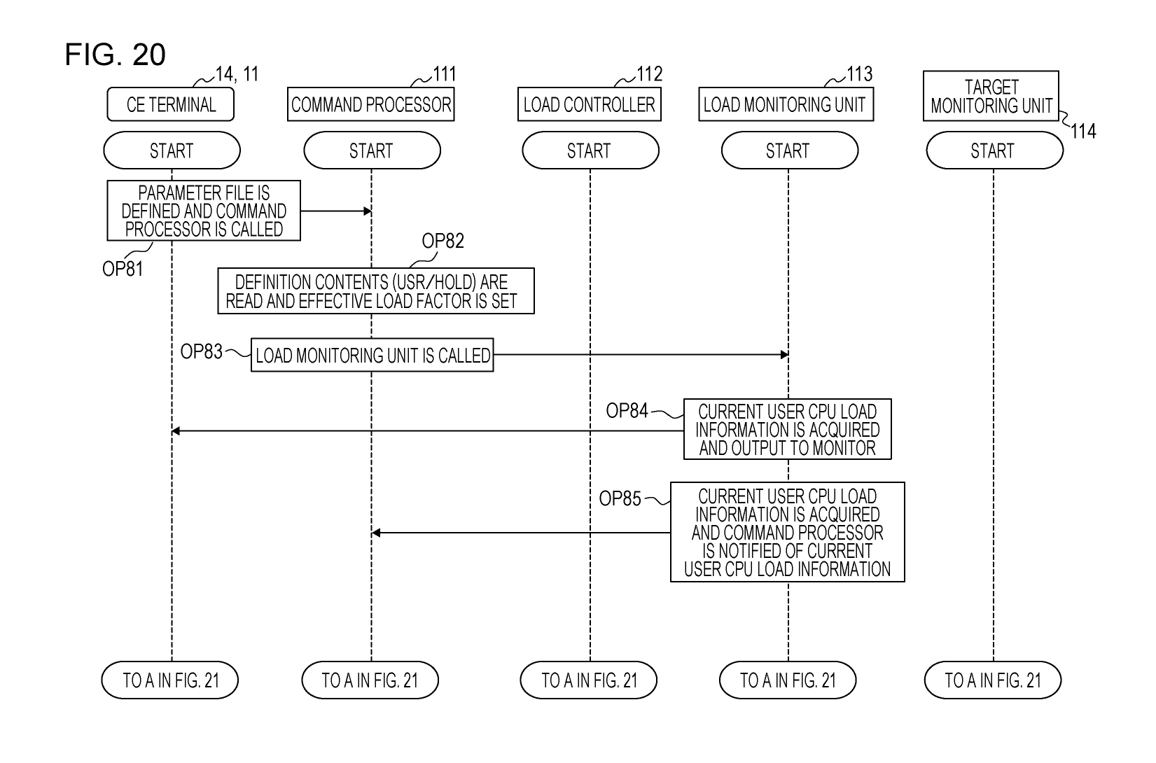

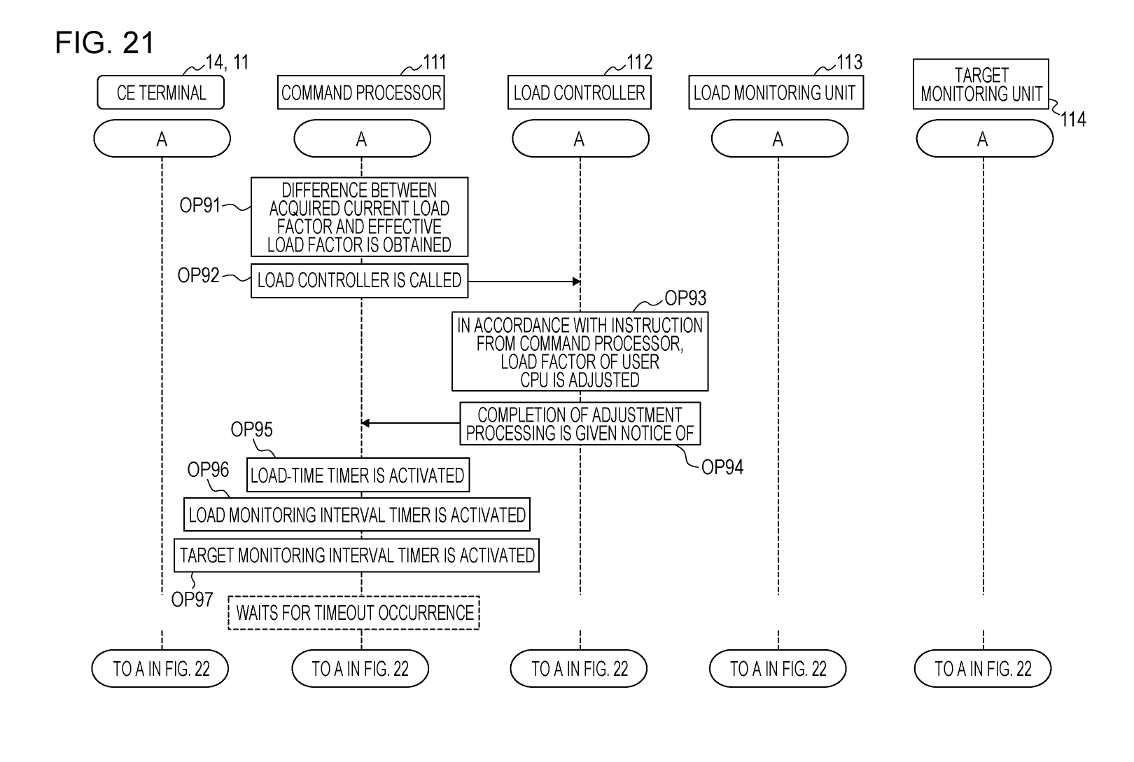

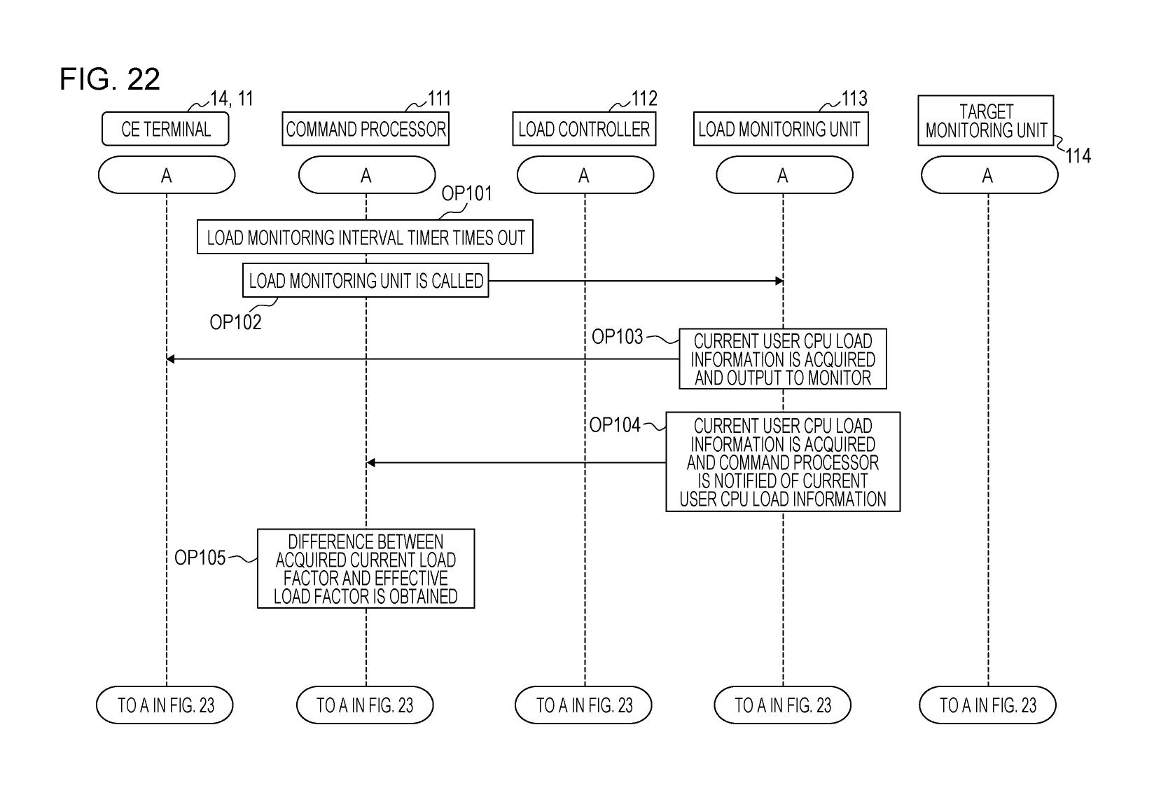

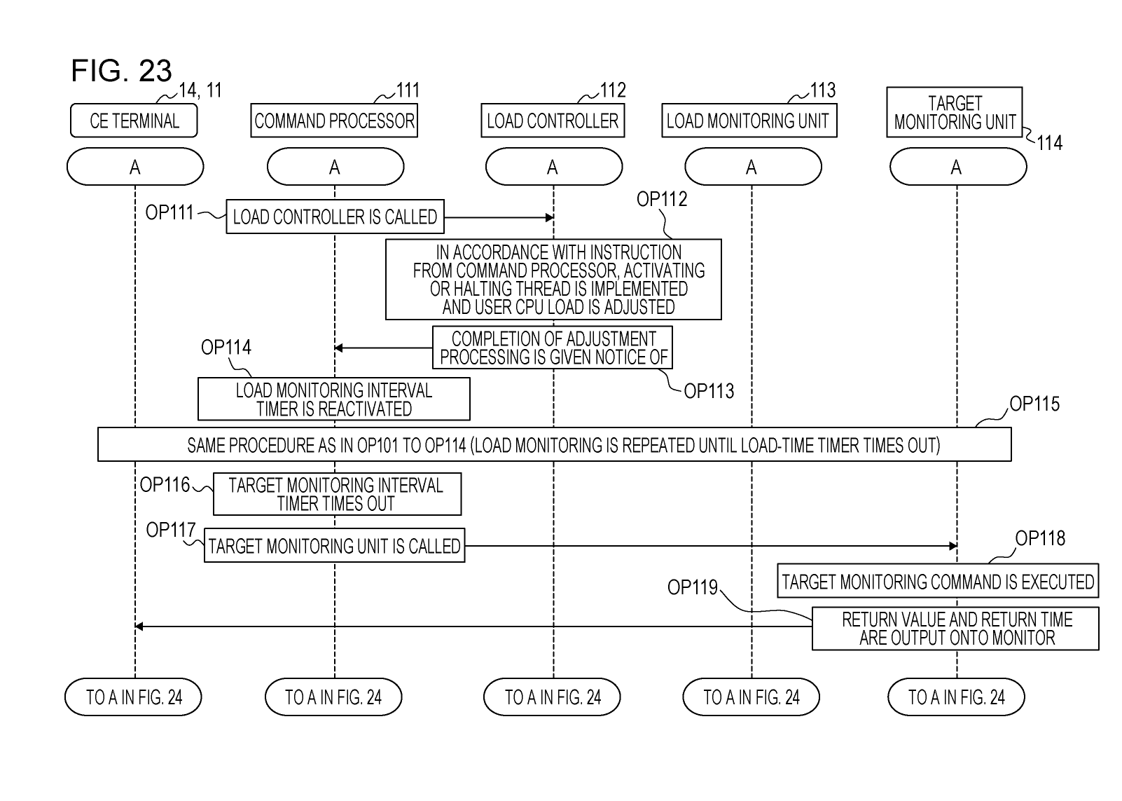

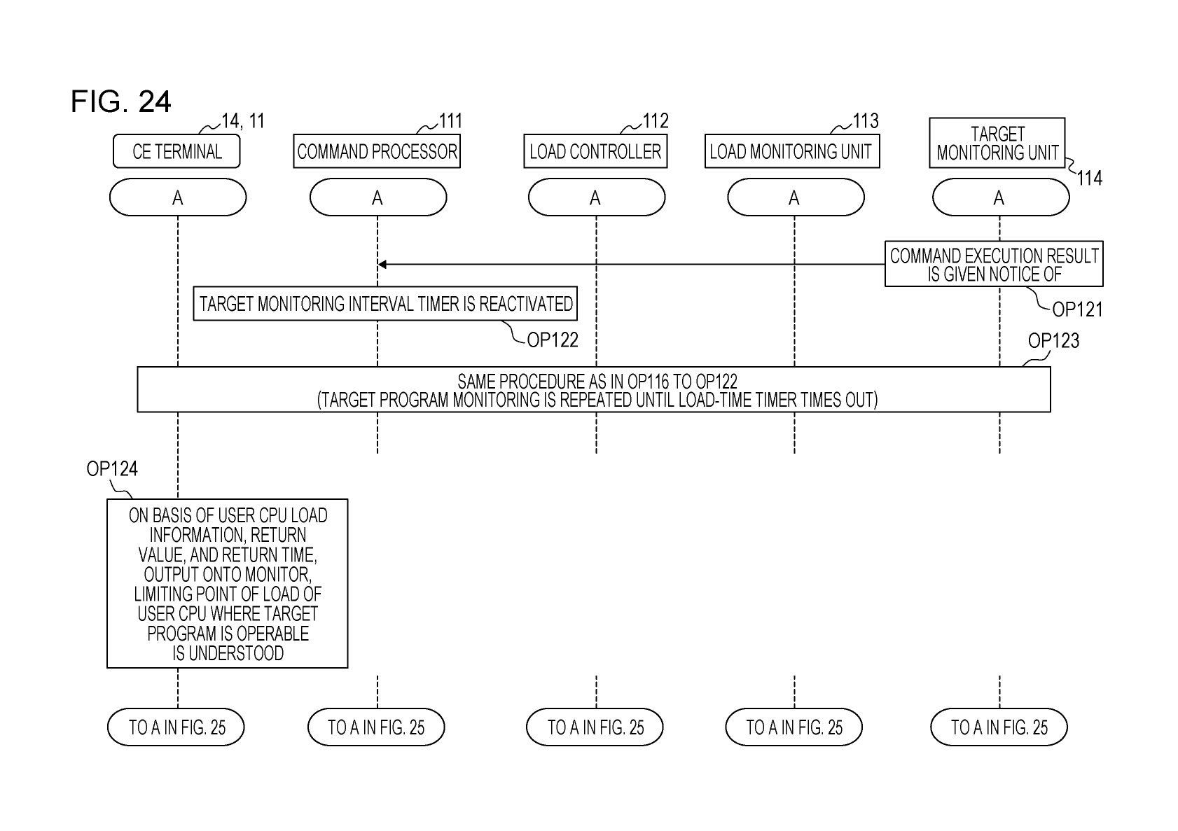

FIG. 20 to FIG. 25 are sequence diagrams illustrating an example of the operation of the load control device 1000B according to the third embodiment. Processing illustrated in FIG. 19 is followed by “A” in FIG. 20. Processing illustrated in FIG. 20 is followed by “A” in FIG. 21. Processing illustrated in FIG. 21 is followed by “A” in FIG. 22. Processing illustrated in FIG. 22 is followed by “A” in FIG. 23. Processing illustrated in FIG. 23 is followed by “A” in FIG. 24. The processing illustrated in FIG. 19 to FIG. 24 indicates processing performed when, using the CE terminal 14, the CE executes the diagnosis of the operating state of the target program 115B with using the load control device 1000B according to the third embodiment.

As illustrated in FIG. 20, using the CE terminal 14, the CE defines the parameter file 104B, and calls the command processor 111 (OP81). The command processor 111 reads “USR” and “HOLD”, which serve as the definition contents of the parameter file 104B, and sets the effective load factor of the CPU 101 of the user illustrated in FIG. 1 and FIG. 2 (OP82). In the parameter file 104B according to FIG. 19, the load type is defined as “USR”, and the load mode is defined as “HOLD”. Therefore, as the “load factor maximum”, the command processor 111 sets, for example, the load factor of 90% as the effective load factor of the user program area in the CPU 101. The command processor 111 calls the load monitoring unit 113 and acquires the current load factor of the CPU 101 (OP83).

When having received a call from the command processor 111, the load monitoring unit 113 acquires the current CPU load information on the user program area side, and outputs the current CPU load information to the monitor 11 (OP84). The load monitoring unit 113 acquires the current CPU load information of the user program area, and notifies the command processor 111 of the current CPU load information of the user program area (OP85).

As illustrated in FIG. 21, the command processor 111 obtains a difference between the acquired current load factor of the user program area in the CPU 101 and the set effective load factor (OP91). The command processor 111 calls the load controller 112, and causes the load controller 112 to adjust the load factor of the CPU 101 (OP92).

By executing or halting investing a thread in the thread execution unit 112B, the load controller 112 adjusts the load factor of the user program area in the CPU 101 (OP93). Specifically, the load controller 112 decreases a difference between the current load factor of the user program area in the CPU 101 and the set effective load factor, and activates or halts a predetermined thread due to the thread execution unit 112B. The load controller 112 activates or halts a predetermined thread due to the thread execution unit 112B, and adjusts the load factor of the user program area. After having completed processing for adjusting the load factor of the user program area in the CPU 101, the load controller 112 notifies the command processor 111 of the completion of the load adjustment processing (OP94).

The command processor 111 activates the load-time timer, and starts timing a time when the load controller 112 applies a load onto the CPU 101 in the user program area (OP95). The command processor 111 activates the load monitoring interval timer, and starts timing a time interval when the load monitoring unit 113 monitors the load of the CPU 101 in the user program area (OP96). The command processor 111 activates the target monitoring interval timer, and starts timing a time interval when the target monitoring unit 114 monitors the operating state of the target program 115B in the user program area (OP97). After the processing operation in OP97, the command processor 111 shifts to the mode for waiting the timeout occurrence of the timer 101A.

As illustrated in FIG. 22, when having detected that the load monitoring time has elapsed owing to the timeout of the load monitoring interval timer in the mode for waiting the timeout occurrence of the timer 101A (OP101), the command processor 111 calls the load monitoring unit 113 so as to acquire again, from the load monitoring unit 113, the current load factor of the CPU 101 in the user program area (OP102).

The load factor of the CPU 101 fluctuates owing to the operating state of a program other than the target program 115B. In addition, when traffic from another server to the server 100 has increased, the load factor of the CPU 101 fluctuates owing to an increase in the amount of packets transmitted from the other server to the CPU 101. In preparation for the fluctuation of the load factor of the CPU 101, it may be desirable to acquire again the current load factor of the user program area in the CPU 101.

When having a call from the command processor 111, the load monitoring unit 113 acquires again the current load factor of the user program area in the CPU 101, and outputs the acquired current load factor to the monitor 11 (OP103). When having a call from the command processor 111, the load monitoring unit 113 acquires the current load factor of the user program area in the CPU 101, and notifies again the command processor 111 of the acquired load factor of the user program area (OP104).

When having acquired, from the load monitoring unit 113, the current load factor of the user program area in the CPU 101, the command processor 111 obtains again a difference between the acquired current load factor of the user program area in the CPU 101 and the preliminarily set effective load factor (OP105).

As illustrated in FIG. 23, so as to adjust again the load factor of the user program area in the CPU 101 owing to the load controller 112, the command processor 111 calls again the load controller 112 (OP111).

When having received a call from the command processor 111, the load controller 112 adjusts again the load factor of the CPU 101 in the user program area, in the same way as the processing operation in OP93 illustrated in FIG. 21 (OP112). After having completed again the processing for adjusting the load factor of the CPU 101 in the user program area, the load controller 112 notifies again the command processor 111 of the completion of the adjustment processing, in the same way as the processing operation in OP94 illustrated in FIG. 21 (OP113).

When having been notified of the completion of the adjustment processing by the load controller 112, the command processor 111 reactivates the load monitoring interval timer, and resumes timing the time interval when the load monitoring unit 113 monitors the load of the user program area in the CPU 101 (OP114). The above-mentioned processing operations in OP101 to OP114 are repeated until the load-time timer times out and hence the elapse of the set time for applying a load onto the CPU 101 is detected (OP115).

When, owing to the timeout of the target monitoring interval timer in the mode for waiting the timeout occurrence of the timer 101A, having detected the elapse of the time for applying a load onto the CPU 101 (OP116), the command processor 111 calls the target monitoring unit 114, and monitors the execution state of the target program 115B (OP117).

When having received a call from the command processor 111, the target monitoring unit 114 executes a target program monitoring command, and executes the monitoring of the target program 115B (OP118). Specifically, for example, by acquiring the return value at the time of the return of a command or by timing a time having elapsed before the return of the command, the target monitoring unit 114 determines the operating state of the target program 115B. The target monitoring unit 114 causes the return value at the time of the return of the command and the time having elapsed before the return thereof to be output to the monitor 11 (OP119). After having caused the return value and the time having elapsed before the return to be output to the monitor 11, the target monitoring unit 114 outputs, to the monitor 11, the return value and a return time having elapsed before the return, as illustrated in FIG. 24. When having output, to the monitor 11, the return value and the return time having elapsed before the return, the target monitoring unit 114 notifies the command processor 111 of the execution result of the command (OP121). The operating state of the target program 115B is determined from, for example, the value of the return value (returned value) at the time of the return of the command and the measured time having elapsed before the return of the command. As an example, a case where the value of the “return value (returned value)” is “0” indicates normal termination, and a case of “1” indicates abnormal termination, namely, indicates that an error has occurred.

When having been notified of a command execution result by the target monitoring unit 114 (OP121), the command processor 111 reactivates the target monitoring interval timer, and resumes timing the time interval when the target program 115B is monitored (OP122).

The above-mentioned processing operations in OP116 to OP122, namely, target program monitoring processing, are repeated until the load-time timer times out and hence the set time for applying a load elapses (OP123).

The output load information of the CPU 101 in the user program area and the return value and the return time of a command according to the target program 115B are output to the monitor 11. Using the CE terminal 14, on the basis of the information output to the monitor 11, it may become possible for the CE to understand the limiting point of the load of the CPU 101 in the user program area in which the target program 115B is operable (OP124).

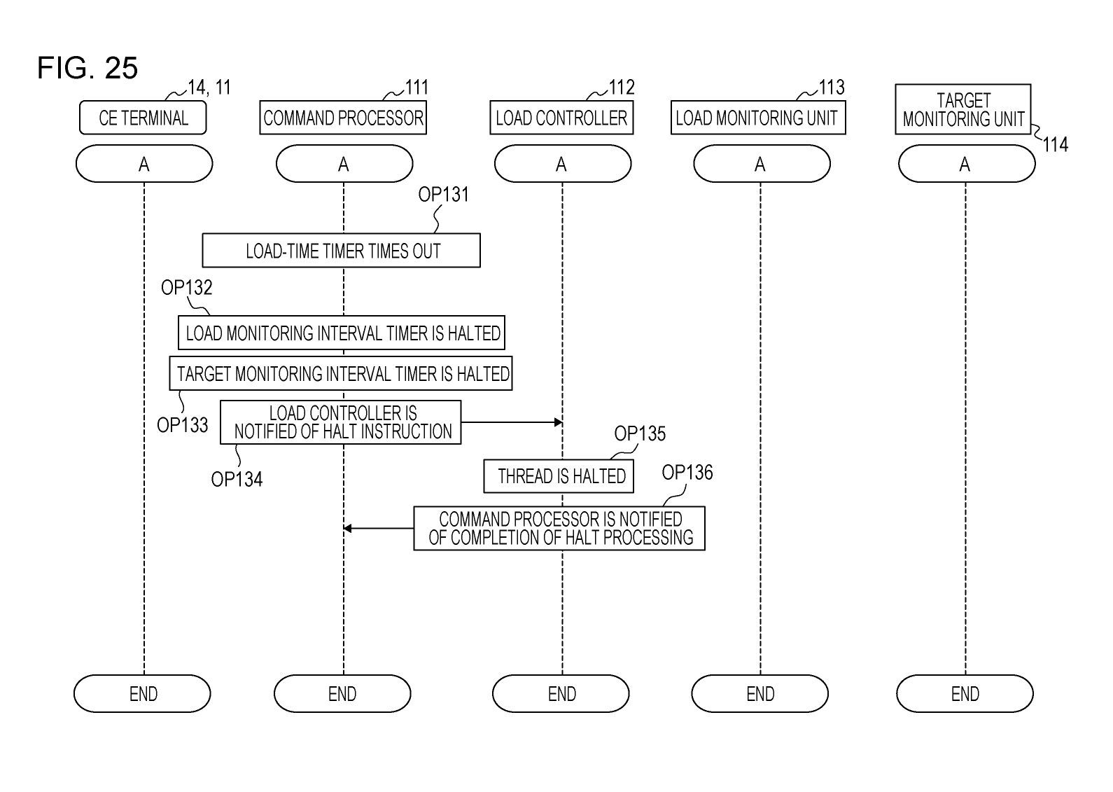

As illustrated in FIG. 25, when, owing to the timeout of the load-time timer in the mode for waiting the timeout occurrence of the timer 101A, having detected the elapse of the set time for applying a load, the command processor 111 causes timing the load-time timer to be halted (OP131) and forcibly causes timing the load monitoring interval timer to be halted (OP132). In the same way, the command processor 111 forcibly causes timing the target monitoring interval timer to be halted (OP133). The command processor 111 notifies the load controller 112 of an instruction for halting the load controller 112 (OP134).

When, by the command processor 111, having been notified of an instruction for halting the load controller 112, the load controller 112 causes all threads to be halted, the threads being invested in the thread execution unit 112B in the CPU 101 so as to apply a load (OP135). After processing for halting the load controller 112 has been completed, the load controller 112 notifies the command processor 111 of the completion of the halt processing (OP136). Owing to the processing operation in OP136, the repetition of the above-mentioned processing operations in OP114 to OP121 is terminated.

According to the load control device 1000B, the load control method, and the load control program according to the third embodiment, the effective load factor of the user program area in the CPU 101 is set, a difference between the effective load factor of the CPU 101 and the current load factor is obtained, and activating a thread and halting a thread are performed. By performing activating a thread and halting a thread, an increase and a decrease in the load factor of the CPU 101 are performed, and the fluctuation of the load factor is suppressed. Therefore, it may be possible to correctly measure the load factor of the CPU 101 when the target program 115B is caused to operate. In addition, it may be possible to correctly measure the load factor of the CPU 101 when the target program 115B is caused to operate in the user space.

According to the disclosed technology, owing to a load detection unit, the load factor of a processor is detected by executing a program for a predetermined time, and a difference between the load factor of the processor, detected by a load-difference detection unit, and the effective load factor of the processor is obtained. Since it may be possible to suppress the fluctuation of the load factor of the processor by activating a thread or halting a thread on the basis of the obtained difference, it may be possible to correctly measure the load factor of the processor when a target program is caused to operate.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A load control device controlling a load of an executed program, the load control device comprising:
an arithmetic processing unit configured to execute the program;
a load detection unit configured to detect a load factor of the arithmetic processing unit;
a load-difference detection unit configured to obtain a difference between a predetermined load factor and the load factor detected by the load detection unit; and
a load controller configured to control, for a predetermined time, the start or stop of the program executed by the arithmetic processing unit so that the arithmetic processing unit has the predetermined load factor on the basis of the difference detected by the load-difference detection unit.

2. The load control device according to claim 1, wherein
the load controller controls the start or stop of the program executed by the arithmetic processing unit, in a kernel space or a user space of the arithmetic processing unit.

3. The load control device according to claim 1, wherein
the load controller controls, for a predetermined time, the start or stop of a partial program executed by the arithmetic processing unit so that the arithmetic processing unit has the predetermined load factor, and controls the start or stop of the partial program executed by the arithmetic processing unit so that the arithmetic processing unit has a second load factor, obtained by increasing or decreasing the predetermined load factor, after the predetermined time has elapsed.

4. The load control device according to claim 3, further comprising:
a storage device configured to store therein setting values including the predetermined load factor, a rate of an increase or a decrease in the load factor, and the predetermined time.

5. A load control method for controlling a load of an information processing device executing a program,
the load control method causing an arithmetic processing unit included in the information processing device to execute a procedure, the procedure comprising:
causing the program to operate;
detecting a load factor of the arithmetic processing unit;
obtaining a difference between a predetermined load factor and the detected load factor of the arithmetic processing unit; and
controlling, for a predetermined time, the start or stop of the program executed by the arithmetic processing unit so that the arithmetic processing unit has the predetermined load factor on the basis of the detected difference.

6. The load control method according to claim 5, wherein
the start or stop of the partial program executed by the arithmetic processing unit on the basis of the detected difference is the start or stop of the thread in a kernel space or a user space of the arithmetic processing unit.

7. The load control method according to claim 5, the procedure further comprising:
controlling, for a predetermined time, the start or stop of the partial program executed by the arithmetic processing unit so that the arithmetic processing unit has the predetermined load factor, and controls the start or stop of the partial program executed by the arithmetic processing unit so that the arithmetic processing unit has a second predetermined load factor, obtained by increasing or decreasing the predetermined load factor, after the predetermined time has elapsed.

8. The load control method according to claim 7, wherein
the load control device further includes
a storage device configured to store therein setting values including the predetermined load factor, a rate of an increase or a decrease for increasing or decreasing the load factor, and a control time of the load factor.

9. A computer-readable recording medium storing a load control program for causing an arithmetic processing unit included in the information processing device to execute a procedure, the procedure comprising:
causing a program to operate,
detecting a load factor of the arithmetic processing unit,
obtaining a difference between a predetermined load factor and the detected load factor of the arithmetic processing unit, and
controlling, for a predetermined time, the start or stop of the program executed by the arithmetic processing unit so that the arithmetic processing unit has the predetermined load factor on the basis of the detected difference.

10. The computer-readable recording medium according to claim 9, wherein
the start or stop of the partial program executed by the arithmetic processing unit on the basis of the detected difference is the start or stop of the thread in a kernel space or a user space of the arithmetic processing unit.

11. The computer-readable recording medium according to claim 10, the procedure further comprising:
controlling, for a predetermined time, the start or stop of the partial program executed by the arithmetic processing unit so that the arithmetic processing unit has the predetermined load factor, and controls the start or stop of the partial program executed by the arithmetic processing unit so that the arithmetic processing unit has a second predetermined load factor, obtained by increasing or decreasing the predetermined load factor, after the predetermined time has elapsed.

12. The computer-readable recording medium according to claim 11, wherein
the information processing device further includes
a storage device configured to store therein setting values including the predetermined load factor, a rate of an increase or a decrease for increasing or decreasing the load factor, and a control time of the load factor.
